(19) United States
(12) Patent Application Publication
(10) Pub. No.: US 2010/0033694 A1
(43) Pub. Date: Feb. 11, 2010

(54) Exposure method, exposure apparatus and device manufacturing method

(75) Inventors: Saburo Kamiya, Tokyo (JP); Shigeru Hagiwara, Kumagaya-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/458,898

(22) Filed: Jul. 27, 2009

Related U.S. Application Data
(60) Provisional application No. 61/136,078, filed on Aug. 11, 2008.
(60) Provisional application No. 61/136,079, filed on Aug. 11, 2008.

(30) Foreign Application Priority Data
Aug. 1, 2008 (JP) 2008-199197
Aug. 1, 2008 (JP) 2008-199445

(51) Int. Cl. G03B 27/52

(52) U.S. Cl. 355/30

(57) ABSTRACT

An exposure apparatus which exposes a wafer with an illumination light via a reticle includes a vortex tube which generates a cool gas and a warm gas from a compressed gas injected from a compressed gas supply tube; a flow rate control valve and a Y-shaped joint which mix the cool gas and the warm gas generated from the vortex tube at a variable mixing ratio to output a temperature-controlled gas; and a gas supply duct which supplies the temperature-controlled gas to a heat source or a vicinity thereof. It is possible to perform the local temperature control or the local cooling by the simple mechanism without using any refrigerant or any cooling medium.

### CROSS-REFERENCES TO RELATED APPLICATIONS

This application claims the benefit of priority of Japanese Patent Application No. 2008-199197 filed on Aug. 1, 2008, Japanese Patent Application No. 2008-199445 filed on Aug. 1, 2008, U.S. Provisional Application Ser. No. 61/136,078 filed on Aug. 11, 2008, and U.S. Provisional Application Ser. No. 61/136,079 filed on Aug. 11, 2008, the entire disclosures of which are incorporated herein by reference.

### BACKGROUND OF THE INVENTION

1. Field of the Invention

The present invention relates to an exposure technique using a temperature control technique. The present invention is preferably applicable, for example, when the temperature is controlled for a member constructing an exposure apparatus to be used for producing various devices including semiconductor devices, liquid crystal displays, etc. The present invention also relates to a device-producing technique using such an exposure technique.

2. Description of the Related Art

In the lithography step as one of the steps of producing the semiconductor device (electronic device, microdevice), for example, an exposure apparatus, which is exemplified by a projection exposure apparatus such as the stepper or the like of the full field exposure type (stationary exposure type) or a projection exposure apparatus such as the scanning stepper or the like of the scanning exposure type, etc. is used in order that a pattern, which is formed on a reticle (or a photomask or the like), is transferred onto a wafer (or a glass plate or the like) which is coated with a resist to perform the exposure.

In order to perform the exposure at a high exposure accuracy (a positioning accuracy, a synchronization accuracy, etc.) while maintaining predetermined states of the illumination characteristic of the illumination optical system and the imaging characteristic of the projection optical system and maintaining a predetermined relationship of the positional relationship among the reticle, the projection optical system, and the wafer, it is necessary that the temperatures of the reticle stage and the wafer stage and the temperature of an optical member which affects the illumination characteristic and the imaging characteristic should be maintained to be within target temperature ranges. For this purpose, the illumination optical system, the reticle stage, the projection optical system, and the wafer stage of the exposure apparatus have been hitherto arranged or disposed in a box-shaped chamber; and a clean air, which is controlled to have a predetermined temperature and which is made to pass through a dust-preventive filter or a dustproof filter, is supplied into the chamber in the down flow manner.

Recently, the local temperature control is also performed, wherein the air, which is temperature-controlled to a higher extent, is supplied in the down flow manner and/or sideflow manner to a portion for which an especially high temperature control accuracy is required among the mechanisms arranged in the chamber, for example, to an optical path for a measuring beam of a laser interferometer which measures the position of the stage (see, for example, International Publication No. 2006/028188).

In the conventional exposure apparatus, the air which is used to perform the local temperature control in the chamber is also generated, in the same manner as the air which is supplied to the entire chamber in the down flow manner, such that the air incorporated from the outside air and/or the air recovered after being flowing through the chamber is/are made to pass through a dustproof filter and a cooling mechanism using, for example, a refrigerant or cooling medium.

However, in a case that the number of portions to be subjected to the local temperature control in the chamber is increased in order to further enhance the exposure accuracy in future, it may be assumed that the temperature control should be performed by using the cooling mechanisms each of which uses the refrigerant or cooling medium for one of the portions. In such a situation, it is feared that the temperature control mechanism might be complicated and the frequency of the maintenance might be increased.

### SUMMARY OF THE INVENTION

In consideration of such a viewpoint, an object of the present invention is to provide an exposure technique which makes it possible to perform the local cooling or the local temperature control by a simple mechanism without using any refrigerant or any cooling medium and a device-producing technique which uses the exposure technique.

According to a first aspect of the present invention, there is provided an exposure method for illuminating a pattern with an exposure light to expose an object with the exposure light via the pattern, the exposure method comprising: injecting a gas into a vortex tube; adjusting a mixing ratio between a cool gas and a warm gas generated from the vortex tube to produce a temperature-controlled gas; and supplying the temperature-controlled gas to a heat source or a vicinity of the heat source.

According to a second aspect of the present invention, there is provided an exposure method for illuminating a pattern with an exposure light to expose an object with the exposure light via the pattern, the exposure method comprising: injecting a gas into a vortex tube; separating a cool gas and a warm gas generated from the vortex tube into first and second cool gases and first and second warm gases respectively; controlling flow rates of the first cool gas and the first warm gas based on temperature information of a first gas obtained by mixing the first cool gas and the first warm gas; supplying the first gas to a first temperature control area; and supplying a second gas obtained by mixing at least a part of the second cool gas and at least a part of the second warm gas to a second temperature control area for which a target temperature control accuracy is lower than that of the first temperature control area.

According to a third aspect of the present invention, there is provided an exposure method for illuminating a pattern with an exposure light to expose an object with the exposure light via the pattern, the exposure method comprising: generating a gas having an increased flow rate with suction of a surrounding gas surrounding a slit portion by a negative pressure obtained when a compressed gas is jetted through the slit portion; and supplying the gas having the increased flow rate to a heat source or a vicinity of the heat source.

According to a fourth aspect of the present invention, there is provided an exposure apparatus which illuminates a pattern with an exposure light and exposes an object with the exposure light via the pattern, the exposure apparatus comprising: a vortex tube which generates a cool gas and a warm gas from a compressed gas injected from a compressed gas source; a gas mixing section which mixes the cool gas and the warm gas generated from the vortex tube at a variable mixing ratio to output a temperature-controlled gas; and a gas supply passage which supplies the temperature-controlled gas to a heat source or a vicinity of the heat source.

According to a fifth aspect of the present invention, there is provided an exposure apparatus which illuminates a pattern with an exposure light and exposes an object with the exposure light via the pattern, the exposure apparatus comprising: a vortex tube which generates a cool gas and a warm gas from a gas injected from a gas source into the vortex tube; first and second separating sections which separate the cool gas and the warm gas generated from the vortex tube into first and second cool gases and first and second warm gases, respectively; first and second mixing sections which mix the first cool gas and the first warm gas and which mix at least a part of the second cool gas and at least a part of the second warm gas, respectively; a temperature sensor which measures temperature information of a first gas outputted from the first mixing section; a controller which controls flow rates of the first cool gas and the first warm gas based on the information measured by the temperature sensor; a first gas supply passage which supplies the first gas to a first temperature control area; and a second gas supply passage which supplies a second gas outputted from the second mixing section to a second temperature control area having a target temperature control accuracy lower than that of the first temperature control area.

According to a sixth aspect of the present invention, there is provided an exposure apparatus which illuminate a pattern with an exposure light and exposes an object with the exposure light via the pattern, the exposure apparatus comprising: a piping which guides a compressed gas from a compressed gas source; a gas-amplifying section including an injection port into which the compressed gas is injected via the piping, a groove portion which is communicated with the injection port, an outside gas suction port which is provided adjacently to the groove portion, and a blow port from which a gas outflowed from the groove portion and an outside gas sucked from the outside gas suction port are blown; and a gas supply passage which supplies the gases blown from the gas-amplifying section to a heat source or a vicinity of the heat source.

According to a seventh aspect of the present invention, there is provided a method for producing a device, comprising: forming a pattern of a photosensitive layer on a substrate by using the exposure method or the exposure apparatus of the present invention; and processing the substrate formed with the pattern.

According to the present invention, it is possible to perform, without using any coolant, the local temperature control or cooling with the simple mechanism by using the temperature-controlled gas generated from the compressed gas using the vortex tube or by using the gas obtained by amplifying the compressed gas. Any gas, which is supplied from a compressed air source, etc. provided, for example, in an ordinary factory, can be used as the compressed gas. Therefore, it is also unnecessary to especially provide any exclusive gas-compressing equipment, etc.

### BRIEF DESCRIPTION OF THE DRAWINGS

FIG. 1 shows, with partial cutaway, an exemplary construction of an exposure apparatus according to an embodiment.

FIG. 2 shows a block diagram illustrating a control system of the exposure apparatus shown in FIG. 1.

FIG. 3 is a block diagram of the construction of a second local air-conditioning device 43 shown in FIG. 1.

FIG. 4 is a sectional view of a vortex tube 45 shown in FIG. 3.

FIG. 5 shows a flow chart illustrating an example of the air-conditioning operation of the exposure apparatus shown in FIG. 1.

FIG. 6A shows, with partial cutaway, main components of a first modification of the embodiment, and FIG. 6B shows a sectional view taken along a line VIB-VIB shown in FIG. 6A.

FIG. 7 is a sectional view of main components of a second modification of the embodiment.

FIG. 8 shows, with partial cutaway, the construction of an exposure apparatus according to a second embodiment.

FIG. 9 shows a block diagram illustrating a control system of the exposure apparatus shown in FIG. 8.

FIG. 10 is a block diagram of the construction of a third local air-conditioning device 143 shown in FIG. 8.

FIG. 11 shows a flow chart illustrating an example of the air-conditioning operation of the exposure apparatus shown in FIG. 8.

FIG. 12 is a perspective view of an exemplary arrangement of a reticle stage and a reticle interferometer shown in FIG. 8.

FIG. 13 shows, with partial cutaway, an exposure apparatus of a modification.

FIG. 14 is a sectional view of main components of a local air-conditioning device according to a third embodiment.

FIG. 15 shows a flow chart illustrating exemplary steps of producing an electronic device.

### DESCRIPTION OF THE PREFERRED EMBODIMENTS

### First Embodiment

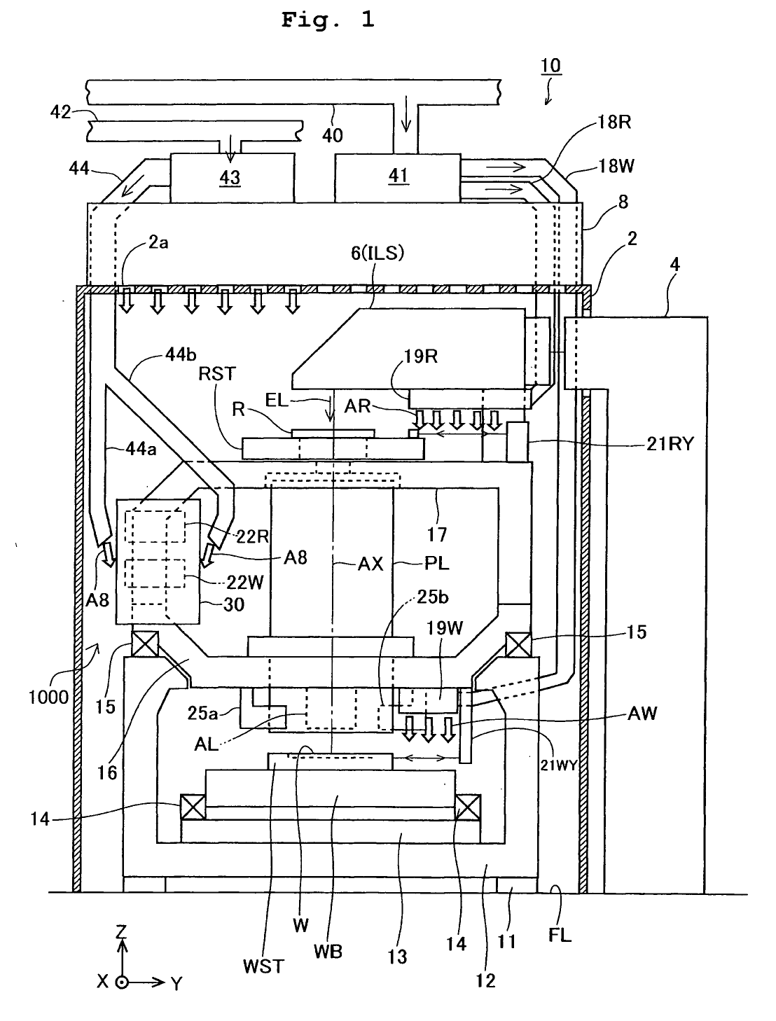

An exemplary first embodiment of the present invention will be explained below with reference to FIGS. 1 to 5. In this embodiment, the present invention is applied to a case in which the temperature control is performed for a scanning exposure type projection exposure apparatus (scanning type exposure apparatus) constructed of a scanning stepper (scanner).

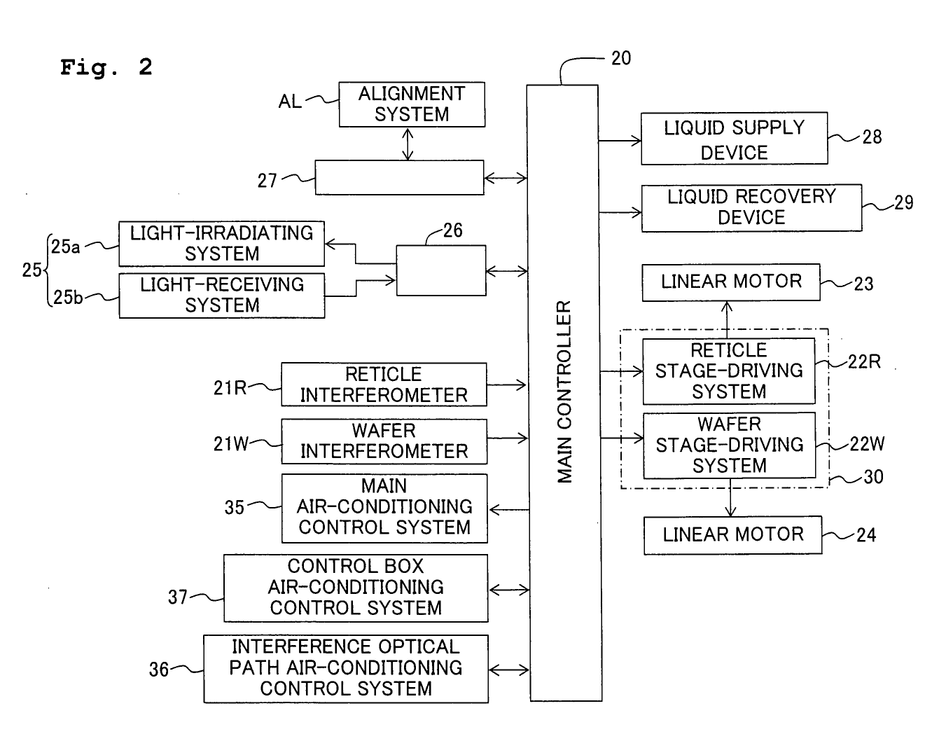

FIG. 1 shows, with partial cutaway, an exposure apparatus 10 according to this embodiment. With reference to FIG. 1, the exposure apparatus 10 is arranged, for example, on a floor FL in a clean room of a semiconductor device production factory. The exposure apparatus 10 includes a light source section 4 which generates an illumination light or illumination light beam EL (exposure light or exposure light beam) for the exposure, an illumination optical system ILS which illuminates a reticle R (mask) with the illumination light EL, a reticle stage RST which is movable while attracting and holding the reticle R, and a projection optical system PL which projects an image of a pattern (pattern image) of the reticle R onto a wafer W (substrate). The exposure apparatus 10 further includes a wafer stage WST which is movable while attracting and holding the wafer W; a control system (see FIG. 2) which includes a main controller 20 constructed of a computer integrally controlling the operation of the exposure apparatus 10; other driving mechanism, support mechanism, sensor, etc.; and a box-shaped chamber 2 which accommodates the illumination optical system ILS, the reticle stage RST, the projection optical system PL, the wafer stage WST, etc. The main controller 20 is arranged outside the chamber 2. The members accommodated in the chamber 2 and including the illumination optical system ILS, the reticle stage RST, the projection optical system PL, the wafer stage WST, etc. are generally referred to appropriately as “exposure apparatus-body 1000”.

The exposure apparatus 10 is provided with an overall air-conditioning system in order to perform the air-conditioning for the interior of the chamber 2 as a whole. The overall air-conditioning system includes a main air-conditioning apparatus 8 which supplies the temperature-controlled clean air (for example, dry air) made or allowed to pass through a dustproof filter or a dust-preventive filter (HEPA filter, ULPA filter, etc.) into the chamber 2 in the down flow manner via a large number of openings 2a formed at an upper portion of the chamber 2, and a main air-conditioning control system 35 (see FIG. 2) which controls the operation of the main air-conditioning apparatus 8. As an example, the air, which is made to flow through the chamber 2, flows to a piping (not shown) disposed under the floor via a large number of openings (not shown) provided through the floor FL of the bottom surface of the chamber 2. The air, which is included in the piping, is reused by being returned to a gas recovery section of the main air-conditioning apparatus 8.

The following explanation will be made with reference to FIG. 1 assuming that the Z axis extends in parallel to an optical axis AX of the projection optical system PL, the X axis extends perpendicularly to the sheet surface of FIG. 1 in a plane perpendicular to the Z axis, and the Y axis extends in parallel to the sheet surface of FIG. 1. In this embodiment, the scanning directions of the reticle R and the wafer W during the scanning exposure are in a direction parallel to the Y axis (Y direction). The directions of rotation about the X axis, the Y axis, and the Z axis are referred to as “θx, θy, and θz directions” respectively as well.

At first, the light source section 4, which is arranged on the floor FL outside the chamber 2, includes a laser light source (exposure light source) which generates the ArF excimer laser (wavelength: 193 nm) as the illumination light EL, a beam-feeding optical system which guides the illumination light EL to the illumination optical system ILS, and a beam-shaping optical system which shapes the cross-sectional shape of the illumination light EL into a predetermined shape. The light-exit end of the light source section 4 for the illumination light EL is arranged in the chamber 2 via an opening disposed at an upper portion of the side surface in the +Y direction of the chamber 2. Those usable as the exposure light source also include the ultraviolet pulse laser light source such as the KrF excimer laser light source (wavelength: 248 nm) and the like; the high harmonic wave-generating light source of the YAG laser, the high harmonic wave generator of the solid laser (the semiconductor laser, etc.); the mercury lamp (the i-ray, etc.); and the like.

The illumination optical system ILS, which is arranged at the upper portion in the chamber 2, includes a plurality of optical members including, for example, an illuminance-uniformizing optical system (not shown) including an optical integrator (a fly's eye lens, a rod integrator (internal reflection type integrator), a diffraction optical element, etc.), a reticle blind (not shown), a condenser optical system including a plurality of condenser lenses, and an optical path-bending mirror, etc. as disclosed, for example, in Japanese Patent Application Laid-open No. 2001-313250 (corresponding to United States Patent Application Publication No. 2003/0025890). The optical members as described above are supported in an illumination system barrel 6. A slit-shaped illumination area, which is long in the X direction on the reticle R and which is defined by the reticle blind, is illuminated with the illumination light EL at a substantially uniform illuminance by the illumination optical system ILS.

An image of the pattern in the illumination area, which is included in the pattern area formed on the reticle R, is imaged and projected onto the wafer W coated with a resist (photosensitive material) via the projection optical system PL which is telecentric on the both sides and which has a projection magnification β of a reduction magnification (for example, ¼). As an example, the field diameter of the projection optical system PL is about 27 to 30 mm.

A lower frame 12 is arranged on the floor FL in the chamber 2 shown in FIG. 1 via a plurality of pedestals 11. A flat plate-shaped base member 13 is fixed to a central portion of the lower frame 12. A flat plate-shaped wafer base WB is supported on the base member 13, for example, via anti-vibration pedestals 14 disposed, for example, at three positions (or, for example, four positions). The wafer stage WST is placed on the upper surface of the wafer base WB parallel to the XY plane via an air bearing movably in the X direction and the Y direction and rotatably in the Oz direction. An optical system frame 16 is supported at the upper end of the lower frame 12 via anti-vibration pedestals 15 disposed, for example, at three positions (or, for example, four positions) arranged to surround the wafer base WB. The projection optical system PL is arranged in a central opening of the optical system frame 16. An upper frame 17 is fixed on the optical system frame 16 to surround the projection optical system PL. As an example, each of the anti-vibration pedestals 14, 15 is an active type anti-vibration apparatus in which an air damper and an electromagnetic damper such as a voice coil motor or the like are combined. Each of the systems, which includes each of the anti-vibration pedestals 14, 15 and the control system thereof (not shown), constitutes AVIS (Active Vibration Isolation System) as the active type vibration isolation system.

A Y axis laser interferometer 21WY is fixed to the end in the +Y direction of the bottom surface of the optical system frame 16. An X axis laser interferometer (not shown) is fixed to the end in the +X direction of the bottom surface. A wafer interferometer 21W (see FIG. 2), which is constructed of these interferometers, radiates a plurality of axes of measuring beams onto a reflecting surface (or a movement mirror) disposed on a side surface of the wafer stage WST respectively to measure the positions in the X direction and the Y direction of the wafer stage WST at a plurality of positions, for example, with respect to a reference mirror (not shown) disposed on the side surface of the projection optical system PL as a reference; and the wafer interferometer 21W supplies the measured values to a wafer stage-driving system 22W via the main controller 20 shown in FIG. 2. The angles of rotation in the θx, θy, and θz directions of the wafer stage WST are also determined based on the measured values.

Those fixed to the bottom surface of the optical system frame 16 shown in FIG. 1 are an alignment system AL of the off-axis image processing system for measuring the position of an alignment mark on the wafer W, and an autofocus sensor 25 (hereinafter referred to as “AF sensor”) (see FIG. 2) which includes a light-irradiating system 25a and a light-receiving system 25b for optically measuring the position in the Z direction (focus position) at a plurality of measuring points on the wafer W in accordance with the oblique incidence system. The image signal obtained by the alignment system AL is processed by a signal processing system 27 shown in FIG. 2, and thus the position information of a measurement objective mark is determined. The position information is supplied to the main controller 20. The main controller 20 performs the alignment for the wafer W based on the position information. The information of the focus position of the measuring point on the wafer W, which is determined by processing the detection signal obtained by the AF sensor 25 by a signal processing system 26, is supplied to the wafer stage-driving system 22W via the main controller 20.

The wafer stage-driving system 22W controls, for example, the velocity and the positions in the X direction and the Y direction of the wafer stage WST via a driving mechanism including, for example, a linear motor 24 based on the control information from the main controller 20 and the measured value obtained by the wafer interferometer 21W. Further, the wafer stage-driving system 22W controls the angle of rotation in the θz direction. Further, the wafer stage-driving system 22W controls position in the Z direction of the wafer W and the angles of rotation in the θx direction and the θy direction so that the surface of the wafer W is focused on the image plane of the projection optical system PL via a Z driving section included in the wafer stage WST based on the information of the focus position measured by the AF sensor.

A spatial image-measuring system (not shown), which measures the position of the image of the alignment mark of the reticle R formed by the projection optical system PL, is also provided in the wafer stage WST. The main controller 20 performs the alignment for the reticle R based on the measured value obtained by the spatial image-measuring system.

On the other hand, the illumination system barrel 6 of the illumination optical system ILS is fixed to the upper portion in the +Y direction of the upper frame 17. Further, the reticle stage RST is placed on the upper surface of the upper frame 17 parallel to the XY plane via an air bearing so that the reticle stage RST is movable at a constant velocity in the Y direction. The reticle stage RST is also movable in the X direction on the upper surface of the upper frame 17, and it is also rotatable in the θz direction.

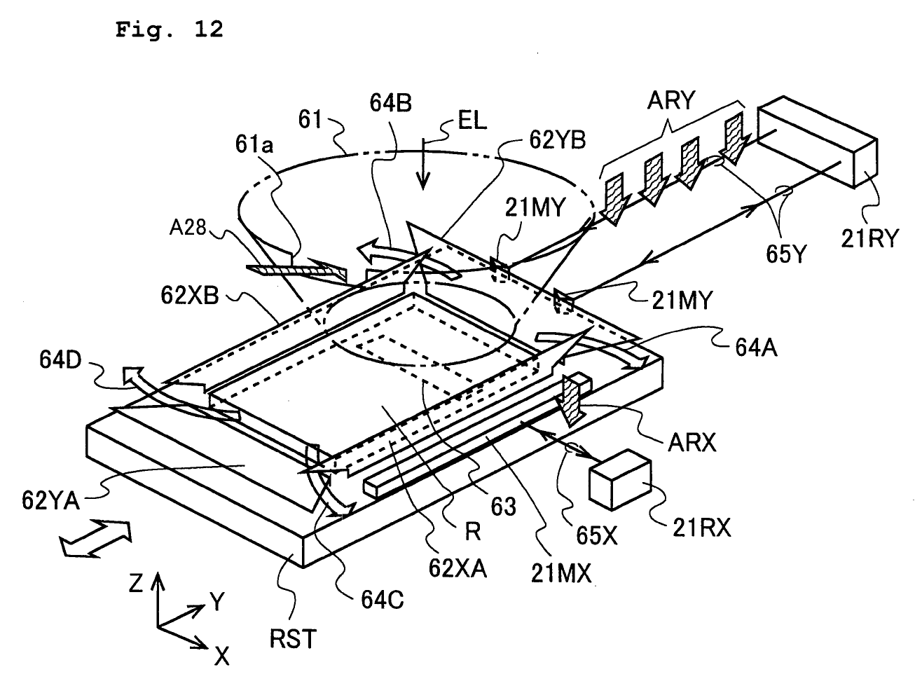

A Y axis laser interferometer 21RY is fixed to the end in the +Y direction of the upper surface of the upper frame 17, and an X axis laser interferometer (see FIG. 12) is fixed to the end in the +X direction of the upper surface. A reticle interferometer 21R (see FIG. 2), which is constructed of these interferometers, radiates a plurality of axes of measuring beams onto a movement mirror (or a reflecting surface) provided on the reticle stage RST respectively to measure the positions in the X direction and the Y direction of the reticle stage RST at a plurality of positions, for example, with respect to a reference mirror (not shown) disposed on a side surface of the projection optical system PL, as a reference; and the reticle interferometer 21R supplies the measured values to a reticle stage-driving system 22R via the main controller 20 shown in FIG. 2. The angles of rotation in the θx, θy, and θz directions of the reticle stage RST are also determined based on the measured values. The reticle stage-driving system 22R controls, for example, the position and the velocity in the Y direction of the reticle stage RST as well as the position in the X direction and the angle of rotation in the θz direction, for example, via a driving mechanism including, for example, a linear motor 23 based on the measured value obtained by the reticle interferometer 21R and the control information from the main controller 20. An example of the arrangement structure of the reticle interferometer and the reticle stage RST will be described in detail with reference to FIG. 12 in a second embodiment described later on. In this specification, the measurement including the focus detection and the alignment for the wafer W and the reticle R, etc. will be appropriately referred to as “measuring operation”.

In this embodiment, the wafer stage-driving system 22W and the reticle stage-driving system 22R behave as heat sources. Therefore, the wafer stage-driving system 22W and the reticle stage-driving system 22R are collectively arranged, as an example, in a box-shaped control box 30 which is supported by the optical system frame 16 in the vicinity of the anti-vibration pedestal 15 in the −Y direction. The control box 30 may be arranged, for example, in the vicinity of the anti-vibration pedestal 15 in the +Y direction. Further, the control box 30 may be supported by the upper frame 17, etc. In this case, other apparatuses or devices including, for example, the AF sensor 25 shown in FIG. 2 and the signal processing systems 26, 27 for the alignment system AL, which have any possibility to behave as the heat source, may be also arranged in the control box 30. Further, the control box 30 may be divided into a plurality of small boxes.

In a case that the exposure apparatus 10 of this embodiment is of the liquid immersion type, for example, a ring-shaped nozzle head (not shown) is arranged on the lower surface of an optical member disposed at the lower end of the projection optical system PL; and a predetermined liquid (pure water or purified water, etc.) is supplied from a liquid supply device 28 shown in FIG. 2 via an unillustrated piping and the nozzle head to a local liquid immersion area disposed between the optical member and the wafer W. The liquid in the liquid immersion area is recovered by a liquid recovery device 29 shown in FIG. 2 via an unillustrated piping. Any liquid immersion mechanism, which is disclosed, for example, in International Publication No. 2004/053955 (corresponding to United States Patent Application Publication No. 2005/0259234), European Patent Application Publication No. 1420298, or International Publication No. 2005/122218 (corresponding to United States Patent Application Publication No. 2007/0291239), is usable as the liquid immersion mechanism which includes the nozzle head, the liquid supply device 28, and the liquid recovery device 29. In a case that the exposure apparatus 10 is of the dry type, it is unnecessary to provide the liquid immersion mechanism.

A reticle loader system (not shown) and a wafer loader system (not shown) are arranged, for example, in the side surface direction in the −Y direction of the chamber 2 shown in FIG. 1. The reticle loader system and the wafer loader system are arranged in a subchamber (not shown) in which the air-conditioning is performed distinctly from the chamber 2. The reticle loader system and the wafer loader system perform the exchange of the reticle R and the wafer W via openings (not shown) formed through the side surface of the chamber 2 respectively.

When the exposure is performed by using the exposure apparatus 10 shown in FIG. 1, the alignment is firstly performed for the reticle R and the wafer W. After that, the radiation or irradiation of the illumination light EL onto the reticle R is started to perform the scanning exposure operation wherein the image of a part of the pattern of the reticle R, which is formed via the projection optical system PL, is projected onto one shot area on the wafer W, while synchronously moving (performing the synchronous scanning for) the reticle stage RST and the wafer stage WST in the Y direction by using a velocity ratio of the projection magnification β of the projection optical system PL, and thus the pattern image of the reticle R is transferred to the shot area. After that, the operation in which the irradiation of the illumination light EL is stopped and the wafer W is step-moved in the X direction and the Y direction via the wafer stage WST and the scanning exposure operation described above are repeated. By doing so, the pattern image of the reticle R is transferred to all of the shot areas on the wafer W in the step-and-scan manner.

Further, the exposure apparatus 10 of this embodiment includes the overall air-conditioning system including the main air-conditioning apparatus 8 which supplies the temperature-controlled clean air into the chamber 2 in the down flow manner in order to perform the exposure at the high exposure accuracy (for example, the positioning accuracy and the synchronization accuracy) while maintaining the predetermined states of the illumination characteristic of the illumination optical system ILS (for example, the coherence factor (a value) and the illuminance uniformity) and the imaging characteristic of the projection optical system (for example, the resolution) and maintaining the predetermined relationship of the positional relationship among the reticle R, the projection optical system PL, and the wafer W. The exposure apparatus 10 further includes the local air-conditioning system which is provided to temperature-control or cool the portion for which the high temperature control accuracy is required and the portion such as the control box 30 or the like which behaves as the heat source. The local air-conditioning system has a first local air-conditioning device 41 and a second local air-conditioning device 43 which are provided outside the upper portion of the chamber 2. At least a part of the overall air-conditioning system (the main air-conditioning apparatus 8 and the local air-conditioning system in this embodiment) is provided at the upper portion of the chamber 2. However, there is no limitation to this. Such components may be provided, for example, at a side portion of the chamber 2.

In order to supply the air-conditioning air to the local air-conditioning system, those arranged, for example, at the upper portion of the chamber 2 (or, for example, at any portion under the floor) are an air-conditioning air supply tube 40 into which the air-conditioning air (for example, the dry air) is supplied as the air controlled to be approximately within a predetermined temperature range and made to pass through the dustproof filter (the HEPA filter or the ULPA filter, etc.); and a compressed air supply tube 42 into which the compressed air (for example, the compressed dry air) is supplied as the air compressed, controlled to be approximately within a predetermined temperature range, and made to pass through the dustproof filter. The compressed air supply tube 42 is the equipment which is generally provided, for example, in the semiconductor production factory. It is allowable to use, for example, an air-conditioning air branched from the interior of the main air-conditioning apparatus 8 or an air incorporated from the compressed air supply tube 42 and subjected to the pressure reduction, rather than using the air-conditioning air supply tube 40.

The first local air-conditioning device 41 is provided, which controls the temperature of the air incorporated from the air-conditioning air supply tube 40 to a higher extent. The clean air, which is temperature-controlled to a high extent by the first local air-conditioning device 41, is guided via a first duct 18R and a second duct 18W to an air feed portion 19R disposed on the bottom surface of the illumination system barrel 6 of the illumination optical system ILS in the chamber 2 and an air feed portion 19W disposed on the bottom surface of the optical system frame 16 respectively. The first local air-conditioning device 41 temperature-controls the air by a compressor using, for example, a refrigerant or a cooling medium. The temperature control operation of the first local air-conditioning device 41 is controlled by an interference optical path air-conditioning control system 36 shown in FIG. 2. The air feed portions 19R, 19W are arranged on the optical paths for the measuring beams of the Y axis laser interferometer 21R for the reticle stage RST and the Y axis laser interferometer 21WY for the wafer stage WST respectively. The air feed portions 19R, 19W discharge the temperature-controlled airs AR, AW guided from the ducts 18R, 18W respectively onto the optical paths for the measuring beams at uniform wind velocity distributions in the down flow manner. It is also possible to blow the airs AR, AW in the side flow manner. Similarly, the temperature-controlled air is also locally supplied to the optical path for the measuring beam of the X axis laser interferometer. Accordingly, it is possible to highly accurately measure the positions of the reticle stage RST and the wafer stage WST by the reticle interferometer 21R and the wafer interferometer 21W. The flows of the air AR (ARY and ARX), which are provided for the optical paths (65X and 65Y) for the measuring beams irradiated onto the reticle stage RST from the X axis laser interferometer and the Y axis laser interferometer (21RX and 21RY), are shown in FIG. 12 described later on.

The second local air-conditioning device 43 is provided, which generates the clean air temperature-controlled relatively highly accurately from the compressed air incorporated from the compressed air supply tube 42. A temperature-controlled air A8 from the second local air-conditioning device 43 is blown, via an air supply duct 44, against the side surfaces of the control box 30 included in the chamber 2. The temperature control operation of the second local air-conditioning device 43 is controlled by the control box air-conditioning control system 37 shown in FIG. 2. As an example, the end portion of the air supply duct 44 is separated into two branched ducts 44a, 44b. The temperature-controlled air A8 is blown against the side surfaces of the control box 30 from the branched ducts 44a, 44b respectively. The preset temperature (target temperature) of the air A8 is set to be low to some extent (for example, by several degrees) as compared with the preset temperature (for example, a predetermined temperature within a range of 20 to 25° C.) supplied by the downflow from the main air-conditioning apparatus 8 into the chamber 2. Accordingly, the increase in temperature is suppressed for the control box 30 including the heat source; and it is possible to enhance the control accuracy of the temperature of each of the portions of the exposure apparatus included in the chamber 2, and it is possible to enhance the exposure accuracy, etc.

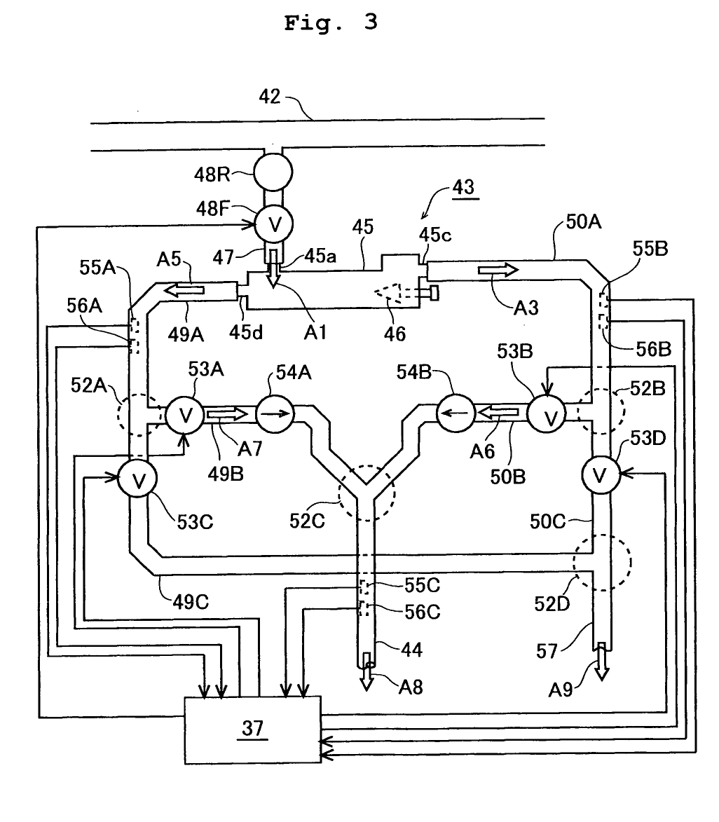

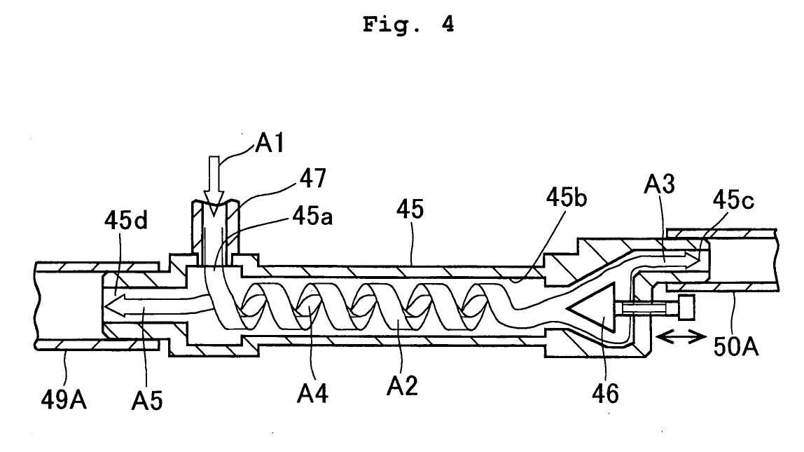

The construction of the second local air-conditioning device 43 will be explained in detail below with reference to FIGS. 3 and 4. FIG. 3 shows a block diagram illustrating the construction of the second local air-conditioning device 43. FIG. 4 is a sectional view of a vortex tube 45 shown in FIG. 3.

With reference to FIG. 3, the second local air-conditioning device 43 is provided with the vortex tube 45 connected to the compressed air supply tube 42 via a piping 47. A regulator 48R for smoothing the pressure and a main flow rate control valve 48F for controlling the flow rate are arranged in the piping 47 at intermediate positions thereof. Pipings 49A, 50A are connected to the vortex tube 45. The vortex tube 45 includes a supply port 45a to which the compressed air A1 is supplied from the compressed air supply tube 42 via the piping 47, a discharge port 45c which discharges, to the piping 50A, a warm gas or warm air A3 having a temperature higher than that of the compressed air A1, a discharge port 45d which discharges, to the piping 49A, a cool gas or cool air A5 having a temperature lower than that of the compressed air A1, and a throttle valve 46 which controls the flow rate ratio between the warm air A3 and the cool air A5 and the temperature of the cool air A5.

As shown in FIG. 4, the vortex tube 45 is a cylindrical member; the discharge port 45d is provided at one end of a swirling chamber 45b disposed in the cylindrical member; the supply port 45a is provided on the side surface disposed in the vicinity thereof; the throttle valve 46 is provided at the other end of the swirling chamber 45b so that the throttle valve 46 can be taken in and out (advanced and retracted) in order to adjust the flow rate of the warm air A3; and the discharge port 45c is provided at the end disposed in the vicinity of the throttle valve 46. In this case, the compressed air A1, which is supplied from the supply port 45a into the swirling chamber 45b, is separated into a free vortex A2 which is an outer swirling flow directed toward the discharge port 45c and a forced vortex A4 which is an inner swirling flow directed toward the discharge port 45d. The temperature of the free vortex A2 is gradually raised, and the temperature of the forced vortex A4 is gradually lowered. A part of the free vortex A2 is discharged as the warm air A3 from the discharge port 45c to the piping 50A, and a part of the forced vortex A4 is discharged as the cool air A5 from the discharge port 45d to the piping 49A.

It is known that the temperature of the cool air A5 can be lowered by about 10 to 70° C. as compared with the compressed air A1 by adjusting the throttle valve 46. In this embodiment, it is assumed that the temperature of the compressed air A1 is, for example, about 20° C. On this assumption, it is possible to generate the cool air A5 having a temperature of, for example, about −50 to 10° C. In this case, the vortex tube 45 has no movable portion. Therefore, the cool air or cool gas can be generated by using the compressed air, substantially without requiring any maintenance.

Examples of freezers or refrigerators, which use the cool air of the vortex tube, are disclosed, for example, in Japanese Patent Application Laid-open No. 2001-255023 (corresponding to United States Patent Application Publication No. 2001/0020366) and Japanese Patent Application Laid-open Nos. 2006-23010 and 2005-180752. The embodiment of the present invention differs therefrom in that the air, which is obtained by mixing the cool air and the warm air at a variable mixing ratio, is used without being limited to only the cool air of the vortex tube.

With reference to FIG. 3 again, the cool air A5 in the piping 49A is supplied while being branched to pipings 49B, 49C by a T-shaped joint 52A, and the warm air A3 in the piping 50A is supplied while being branched to pipings 50B, 50C by a T-shaped joint 52B. Further, a cool air A7 in the piping 49B and a warm air A6 in the piping 50B are mixed with each other by a Y-shaped joint 52C, and the mixture is supplied as a mixed gas (temperature-controlled air A8) to the air supply duct 44. The cool air in the piping 49C and the warm air in the piping 53D are mixed with each other by a T-shaped joint 52D, and the mixture is supplied to a discharge duct 57. The temperature-controlled air A8 in the air supply duct 44 is blown against the side surfaces of the control box 30 shown in FIG. 1. The air A9 in the discharge duct 57 is supplied, for example, to the main air-conditioning apparatus 8, and the air A9 is utilized as the air-conditioning air.

First and second flow rate control valves 53A, 53B are arranged in the pipings 49B, 50B at intermediate positions thereof. Third and fourth flow rate control valves 53C, 53D are arranged in the pipings 49C, 50C at intermediate positions thereof. Check valves 54A, 54B are arranged in the pipings 49B, 50B at intermediate positions thereof in order to avoid any reverse flow (back flow) of the gas from the Y-shaped joint 52C. Further, a temperature sensor 55A and a flow rate sensor 56A for measuring the temperature and the flow rate of the cool air A5 respectively are arranged in the piping 49A. A temperature sensor 55B and a flow rate sensor 56B for measuring the temperature and the flow rate of the warm air A3 respectively are arranged in the piping 50A. A temperature sensor 55C and a flow rate sensor 56C for measuring the temperature and the flow rate of the air A8 respectively are arranged in the air supply duct 44.

Measured values of the temperature sensors 55A to 55C and the flow rate sensors 56A to 56C are supplied to the control box air-conditioning control system 37. The control box air-conditioning control system 37 controls the opening degrees (0 to 100%) of the main flow rate control valve 48F and the flow rate control valves 53A to 53D based on the measured values and the control information (the preset temperature, the preset flow rate of the air A8, etc.) supplied from the main controller 20. The control box air-conditioning control system 37 may further perform the control of the air pressure supplied from the regulator 48R and/or the throttle valve 46 of the vortex tube 45 (control of the flow rate and the temperature of the cool air A5). The second local air-conditioning device 43 is constructed to include the vortex tube 45, the pipings 47, 49A to 49C, 50A to 50C, the regulator 48R, the main flow rate control valve 48F, the T-shaped joints 52A, 52B, 52D, the Y-shaped joint 52C, the flow rate control valves 53A to 53D, the check valves 54A, 54B, the air supply duct 44, the discharge duct 57, the temperature sensors 55A to 55C, and the flow rate sensors 56A to 56C as described above. Check valves may be arranged in the pipings 49C, 50C at intermediate positions thereof in order to avoid any reverse flow of the gas from the T-shaped joint 52D. Valves (for example, relief valves) may be provided, instead of the flow rate control valves 53C, 53D, so as to release the air, which cannot pass through the flow rate control valves 53A, 53B, toward the discharge duct 57.

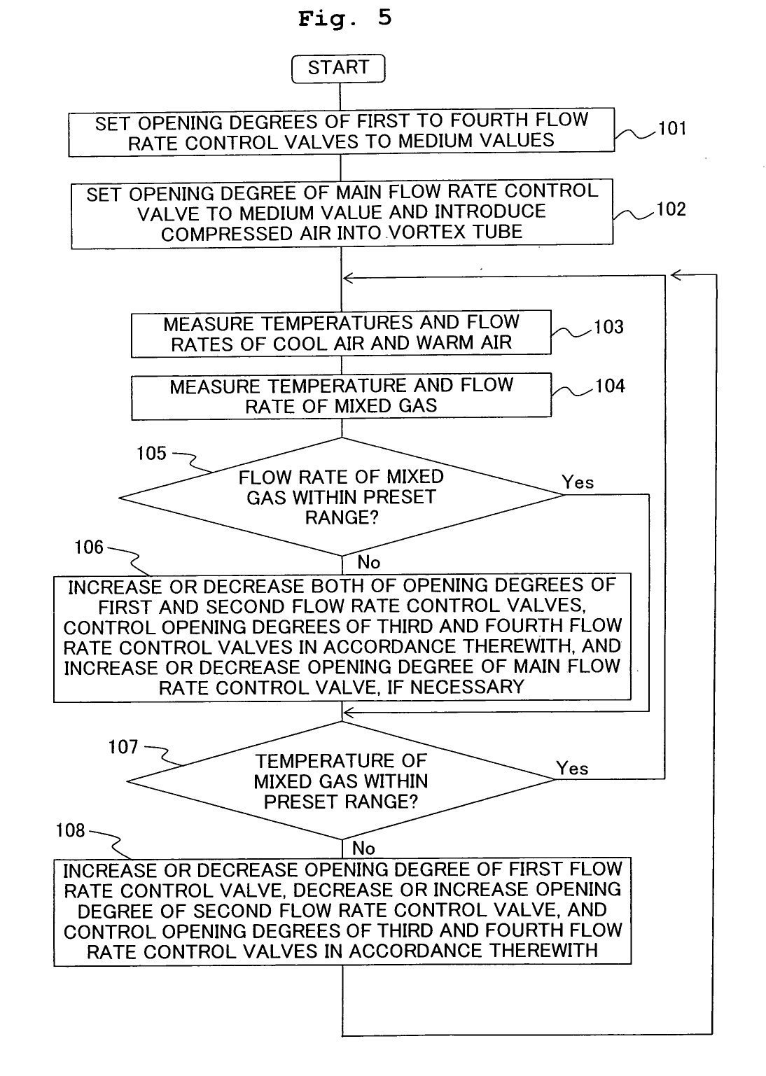

Next, an example of the air-conditioning operation of the second local air-conditioning device 43 shown in FIG. 3 will be explained with reference to a flow chart shown in FIG. 5. This operation is controlled by the control box air-conditioning control system 37 so that this operation is executed concurrently with the exposure operation of the exposure apparatus 10. This operation may be executed concurrently with any other operation, for example, the measuring operation without being limited only to the exposure operation. Alternatively, this operation may be executed continuously during the operation of the exposure apparatus 10. In this procedure, the following assumption is affirmed. That is, the air, which is outputted from the regulator 48R, has a pressure which is set to be, for example, about three to five times the atmospheric pressure; and the throttle valve 46 of the vortex tube 45 is adjusted so that the cool air A5 has a lower temperature and the warm air A3 has a higher temperature than the preset temperature (for example, a predetermined temperature within a range of 15 to 20° C.) of the air A8 fed to the control box 30 shown in FIG. 1. The preset flow rate of the air A8 is set to be, as an example, smaller than the flow rate of the compressed air A1 to be obtained when the opening degree of the main flow rate control valve 48F is set in the vicinity of the median or medium value (50%).

At first, in Step 101 shown in FIG. 5, the opening degrees of the first to fourth flow rate control valves 53A to 53D are set, for example, to the medium values. Subsequently, in Step 102, the opening degree of the main flow rate control valve 48F is set, for example, to the medium value, and the compressed air A1 is introduced from the compressed air supply tube 42 via the piping 47 into the vortex tube 45. Accordingly, from the vortex tube 45, the cool air A5 is supplied to the piping 49A and the warm air A3 is supplied to the piping 50A. The cool air A7, which is branched from the piping 49A to the piping 49B, is mixed by the Y-shaped joint 52C with the warm air A6 which is branched from the piping 50A to the piping 50B, and the mixture is supplied to the air supply duct 44. During this process, a part of the cool air A5 and a part of the warm air A3, which are not used as the air A8, are discharged to the discharge duct 57 via the pipings 49C, 50C and the T-shaped joint 52D.

Subsequently, the temperatures and the flow rates of the cool air A5 and the warm air A3 are measured by the temperature sensors 55A, 55B and the flow rate sensors 56A, 56B, and the measured values are supplied to the control box air-conditioning control system 37 (Step 103). Further, the temperature and the flow rate of the air A8 as the mixed gas in the air supply duct 44 are measured by the temperature sensor 55C and the flow rate sensor 56C, and the measured values are supplied to the control box air-conditioning control system 37 (Step 104).

After that, the control box air-conditioning control system 37 judges whether or not the measured flow rate of the air A8 is within a preset allowable range (preset range) with respect to a preset value supplied from the main controller 20 (Step 105). If the flow rate is within the preset range, the operation proceeds to Step 107. If the flow rate is not within the preset range, the operation proceeds to Step 106.

In Step 106, if the flow rate of the air A8 is less than the preset range, then the control box air-conditioning control system 37 increases the opening degrees of the first and second flow rate control valves 53A, 53B by a first control amount (for example, several %), and the control box air-conditioning control system 37 decreases the opening degrees of the third and fourth flow rate control valves 53C, 53D so that the amount of increase is offset. On the other hand, if the flow rate of the air A8 is more than the preset range, then the control box air-conditioning control system 37 decreases the opening degrees of the flow rate control valves 53A, 53B by the first control amount, and the control box air-conditioning control system 37 increases the opening degrees of the flow rate control valves 53C, 53D so that the amount of decrease is offset. A control amount of the flow rate itself may be used instead of the first control amount.

If the opening degree of at least one of the flow rate control valves 53A, 53B arrives at a predetermined lower limit (for example, about 10%) or an upper limit (for example, 90%) in Step 106 after repeating the operations ranging from Step 103 to Step 108 many times, the opening degree of the main flow rate control valve 48F may be decreased or increased by a predetermined amount respectively.

Subsequently, in Step 107, the control box air-conditioning control system 37 judges whether or not the measured temperature of the air A8 (mixed gas) is within a preset allowable range (preset range) with respect to the preset value supplied from the main controller 20. If the temperature is within the preset range, the operation returns to Step 103 to repeat the operations of Steps 103 to 108. If the temperature is not within the preset range, the operation proceeds to Step 108.

In Step 108, if the temperature of the air A8 is lower than the preset range, then the control box air-conditioning control system 37 decreases the opening degree of the first flow rate control valve 53A by a second predetermined amount (for example, several %), and the control box air-conditioning control system 37 increases the opening degree of the second flow rate control valve 53B so that the amount of decrease in the flow rate of the air A8 brought about thereby is supplemented. In accordance with the control of the mixing ratio between the cool air A7 and the warm air A6, the ratio of the cool air A7 included in the air A8 is decreased, and the temperature of the air A8 is raised, although the flow rate of the air is not changed. During this process, the opening degrees of the third and fourth flow rate control valves 53C, 53D are increased and decreased so that the amounts of change of the flow rates of the flow rate control valves 53A, 53B are offset.

On the other hand, if the temperature of the air is higher than the preset range, then the opening degree of the flow rate control valve 53A is increased by the second predetermined amount, and the opening degree of the flow rate control valve 53B is decreased so that the amount of increase in the flow rate of the air A8 brought about thereby is offset. Accordingly, the ratio of the cool air included in the air A8 is increased, and the temperature of the air A8 is lowered, although the flow rate of the air is not changed. During this process, the opening degrees of the flow rate control valves 53C, 53D are decreased and increased so that the amounts of change of the flow rates of the flow rate control valves 53A, 53B are offset. A control amount of the flow rate itself may be used instead of the second control amount. After that, the operation returns to Step 103. The operations of Steps 103 to 108 are thereafter repeated until the main controller 20 issues an instruction to stop the air-conditioning to the control box air-conditioning control system 37.

In this procedure, the temperature of the cool air A5 discharged from the vortex tube 45 is lower than the preset temperature of the air A8, and the temperature of the warm air A3 is higher than the preset temperature. Therefore, when the mixing ratio between the cool air A7 and the warm air A6 is adjusted in Step 108, the temperature of the air A8 supplied to the control box 30 shown in FIG. 1 can be easily controlled to be within the preset range.

The function, the effect, etc. of the exposure apparatus 10 of this embodiment are as follows.

(1) The exposure method, which uses the exposure apparatus 10, is the exposure method for illuminating the reticle R with the illumination light EL to expose the wafer W with the illumination light EL via the pattern of the reticle R and the projection optical system PL, the exposure method including Step 102 of injecting the compressed gas A1 into the vortex tube 45; Steps 107, 108 of adjusting the mixing ratio of the cool air A5 (A7) and the warm air A3 (A6) generated from the vortex tube 45 to produce the temperature-controlled air A8; and Step 108 of blowing the air A8 against the side surfaces of the control box 30 accommodating the heat source.

The exposure apparatus 10 includes the second local air-conditioning device 43 and the control box air-conditioning control system 37. The second local air-conditioning device 43 includes the vortex tube 45 which generates the cool air A5 and the warm air A3 from the compressed gas A1 injected from the compressed air supply tube 42, the mixing mechanism (the pipings 49B, 50B, the flow rate control valves 53A, 53B, and the Y-shaped joint 52C) which mixes the cool air A5 and the warm air A3 at the variable mixing ratio to output the temperature-controlled air A8, and the air supply duct 44 which supplies the air A8 to the side surfaces of the control box 30. In this way, the cool air and the warm air are generated from the compressed air by the vortex tube 45, and the mixing ratio between the cool air and the warm air is controlled to generate the temperature-controlled air. Accordingly, it is possible to perform the local temperature control in the chamber 2 by the simple mechanism without using any refrigerant.

Further, the compressed air supply tube 42 is generally provided in the semiconductor device production factory, etc. Therefore, the production cost of the second local air-conditioning device 43 can be suppressed to be low.

(2) The exposure method further includes Steps 105, 106 wherein the flow rate of the cool air A7 is increased or decreased by the flow rate control valve 53A, concurrently with which the flow rate of the warm air A6 is increased or decreased by the flow rate control valve 53B to control the flow rate of the air A8 mixed by the Y-shaped joint 52C. Therefore, it is also possible to easily control the flow rate of the air A8 fed to the control box 30.

The flow rate control steps of Steps 105, 106 may be omitted as well.

(3) The blow ports for the air A8 of the air supply duct 44 shown in FIG. 1 (branched ducts 44a, 44b) are arranged while being directed toward or facing the side surfaces of the control box 30 which accommodates the heat sources; and the air A8 is blown against the side surfaces of the control box 30 in the open system. Therefore, the construction of the local air-conditioning mechanism is simple. However, the air A8 may be directly fed to the heat source such as the reticle stage-driving system 22R included in the control box 30. In this case, it is also allowable that a discharge duct, which discharges the air made to flow through the control box 30, is distinctly provided.

(4) In this embodiment, the heat sources are accommodated in the control box 30. However, for example, the linear motors 23, 24 shown in FIG. 2 or the laser light sources of the reticle interferometer 21R and the wafer interferometer 21W may be regarded as the heat sources, and the temperature-controlled air may be directly fed from the air supply duct 44 to the heat sources.

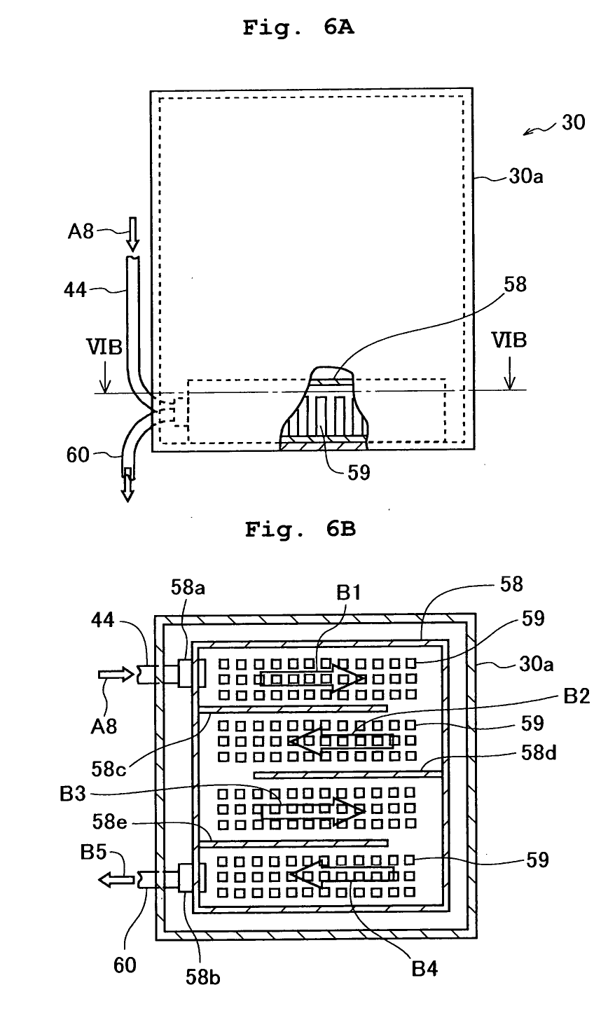

Next, modifications of the foregoing embodiment will be explained. At first, a first modification will be explained with reference to FIGS. 6A and 6B. In the first modification, the second local air-conditioning device 43 shown in FIG. 3 is used as it is. However, the first modification differs in that the control box 30 of the exposure apparatus 10 shown in FIG. 1 is cooled in the heat sink system.

### First Modification

This modification is illustrative of a case of the change of the way of the local air-conditioning for the control box 30 of the exposure apparatus of the first embodiment. The feature, which is different from the first embodiment, is principally explained. Those other than the above are omitted from the explanation because of the similarity to the first embodiment. FIG. 6A shows a construction of main components including a control box 30 of the first modification, and FIG. 6B shows a sectional view taken along a line VIB-VIB shown in FIG. 6A. With reference to FIG. 6A, the heat sources such as the reticle stage-driving system 22R are accommodated in a box-shaped casing 30a of the control box 30 in the same manner as in FIG. 1. A thin box-shaped heat sink portion 58 is fixed onto the bottom surface of the casing 30a. As shown in FIG. 6B, the interior of the heat sink portion 58 is separated by uneven partition plates 58c, 58d, 58e into first, second, third, and fourth spaces having their ends which are communicated with each other. A large number of small prism-shaped or rectangular pillar-shaped heat release fins 59 are provided on the bottom surfaces of the respective spaces respectively. An air supply port 58a is provided on the front surface of the first space of the heat sink portion 58, and a discharge port 58b is provided on the front surface of the fourth space. The air supply duct 44, which extends from the second local air-conditioning device 43 shown in FIG. 1, is connected to the air supply port 58a via an opening of a side surface of the casing 30a. A discharge duct 60, which is connected, for example, to the gas recovery section of the main air-conditioning apparatus 8 shown in FIG. 1, is connected to the discharge port 58b via another opening of the side surface of the casing 30a.

In the first modification, when the local air-conditioning (cooling) is performed for the control box 30, the temperature-controlled air A8, which is generated by the second local air-conditioning device 43 shown in FIG. 1, is supplied via the air supply duct 44 to the air supply port 58a of the heat sink portion 58 included in the control box 30 shown in FIG. 6A. The supplied air A8 passes through the four spaces provided with the large number of heat release fins 59 in the heat sink portion 58 while being bent or turned as shown by arrows B1 to B4. After that, the air A8 is recovered via the discharge duct 60 from the discharge port 58b as shown by an arrow B5. Accordingly, the control box 30 can be cooled efficiently. In the first modification, flexible pipings may be used instead of the air supply duct 44 and the discharge duct 60.

### Second Modification

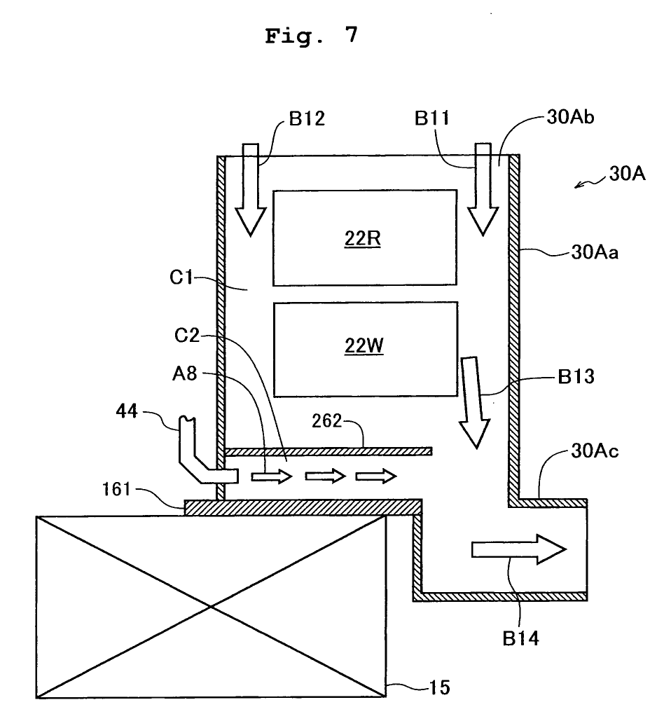

In this modification, the structure of the control box 30 of the exposure apparatus of the first embodiment is changed, and the way of the local air-conditioning is changed. This modification will be explained with reference to FIG. 7. The feature, which is different from those of the first embodiment, will be principally explained. Those other than the above will be omitted from the explanation because of the similarity to the first embodiment. Also in the second modification, the second local air-conditioning device 43 shown in FIG. 3 is used as it is. However, the second modification differs in that a control box 30A, which includes two spaces as shown in FIG. 7, is used instead of the control box 30 of the exposure apparatus 10 shown in FIG. 1.

FIG. 7 is a sectional view of the construction of main components including the control box 30A of the second modification. With reference to FIG. 7, the interior of a box-shaped casing 30Aa of the control box 30A is separated by a gapped partition plate 262 into a first chamber C1 which is a large space and a second chamber C2 which is a small space located on the bottom surface side of the first chamber C1. The heat sources such as the reticle stage-driving system 22R, the wafer stage-driving system 22W, etc. are accommodated in the first chamber C1. The bottom surface of the control box 30A is placed on the anti-vibration pedestal 15 with a flat plate-shaped heat insulating plate 161 intervening therebetween, the heat insulating plate 161 being composed of a material (for example, ceramics) having a small coefficient of thermal conduction. A cylindrical discharge duct portion 30Ac is provided on the bottom surface at the end of the second chamber C2. The blow port of the air supply duct 44 of the second local air-conditioning device 43 shown in FIG. 1 is connected to an opening of the side surface of the second chamber C2 of the control box 30A.

In the second modification, when the exposure is performed with the exposure apparatus, the temperature-controlled airs B11, B12 fed from the main air-conditioning apparatus 8 shown in FIG. 1 in the down flow manner flow into the first chamber C1 from the upper opening 30Ab of the casing 30Aa of the control box 30A shown in FIG. 7. After the airs B11, B12 flow around the heat sources in the first chamber C1, the airs B11, B12 flow into the end of the second chamber C2 from the gap of the partition plate 262 as shown by an arrow B13. Concurrently with this operation, the temperature-controlled air A8, which is generated by the second local air-conditioning device 43 shown in FIG. 1, is supplied to the second chamber C2 from the opening of the casing 30Aa via the air supply duct 44 shown in FIG. 7. The air A8 flowing through the second chamber C2, is merged with the airs B11, B12 flowing through the first chamber C1. After that, the air A8 is discharged to the outside of the casing 30Aa from the discharge duct portion 30Ac as shown by an arrow B14. In this way, the control box 30A can be cooled efficiently by using the downflow brought about by the main air-conditioning apparatus 8 and the local air-conditioning effected by the second local air-conditioning device 43 in combination. In the second modification, the air, which is discharged from the discharge duct portion 30Ac, may be directly recovered to the gas recovery section of the main air-conditioning apparatus 8 shown in FIG. 1 via an piping (not shown), or the air may be discharged to the outside of the chamber 2. Also in the first embodiment and the first modification, the air may be recovered to the gas recovery section, or the air may be discharged to the outside of the chamber so that the air, which is supplied to the control box 30, is not diffused in the chamber 2.

### Second Embodiment

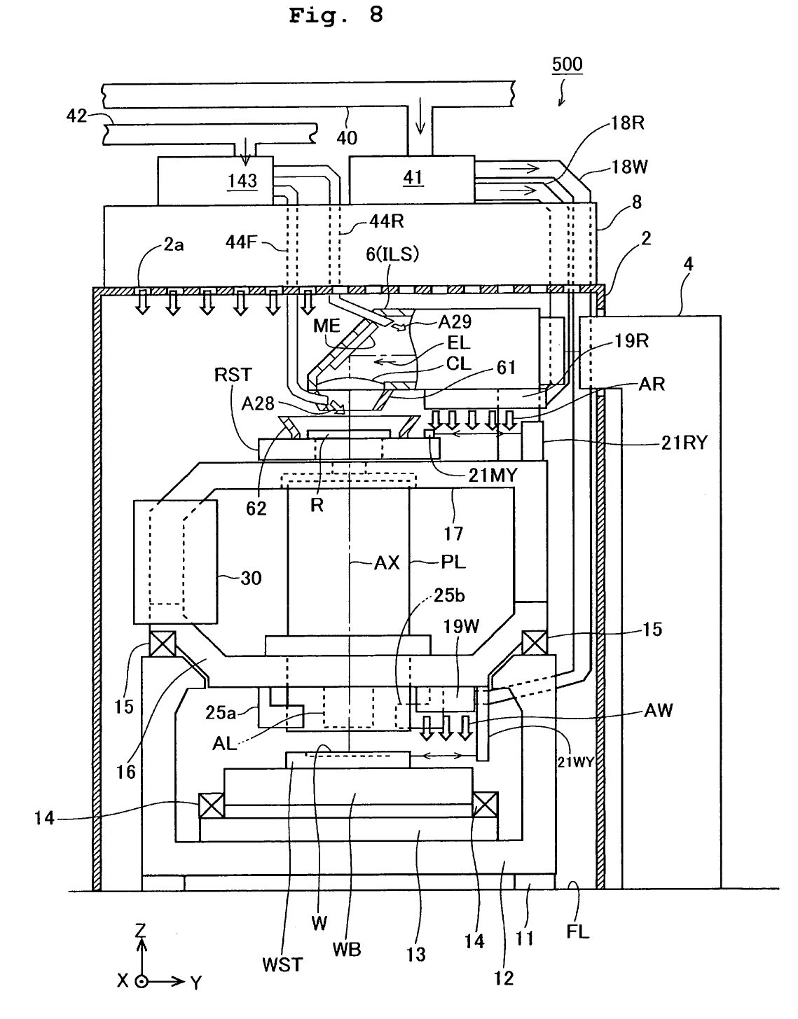

A second embodiment of the exposure apparatus of the present invention will be explained with reference to FIGS. 8 to 12. As shown in FIG. 8, an exposure apparatus 500 of this embodiment is also a scanning exposure type projection exposure apparatus (scanning type exposure apparatus) similarly to the exposure apparatus of the first embodiment. The exposure apparatus 500 includes the overall air-conditioning system including the main air-conditioning apparatus 8 which supplies the temperature-controlled clean air into the chamber 2 in the down flow manner in order to perform the exposure at the high exposure accuracy while maintaining the predetermined states of the illumination characteristic of the illumination optical system ILS and the imaging characteristic of the projection optical system and maintaining the predetermined relationship of the positional relationship among the reticle R, the projection optical system PL, and the wafer W. The exposure apparatus of the second embodiment also executes the local temperature control in the chamber 2. However, the exposure apparatus 500 of this embodiment is principally different from that of the first embodiment in that a third local air-conditioning device 143 is provided instead of the second local air-conditioning device 43, and the gas, which is temperature-controlled and flow rate-controlled by the third local air-conditioning device 143, is introduced into the illumination system barrel 6 and into those disposed thereunder or therebelow. The structure and the operation of the exposure apparatus, which are characteristic of the second embodiment, will be principally explained below. The structure and the operation of the exposure apparatus, which are the same as or equivalent to those of the first embodiment, are omitted from the explanation.

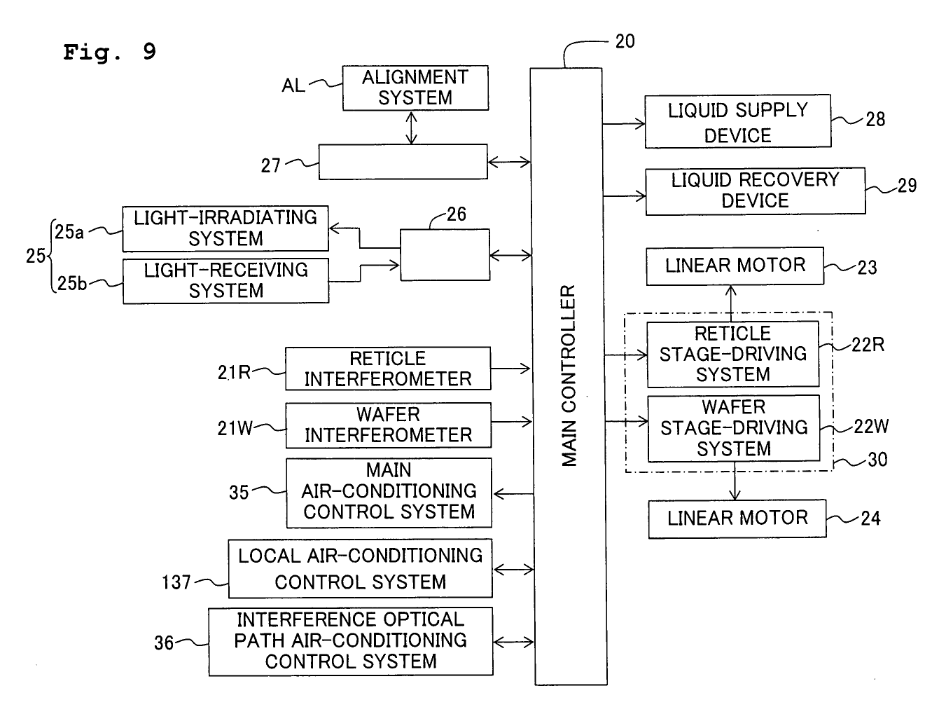

As shown in FIG. 8, the exposure apparatus 500 is provided with the first local air-conditioning device 41 which controls the temperature of the air incorporated from the air-conditioning air supply tube 40 to a higher extent. The clean air, which is temperature-controlled to a high extent by the first local air-conditioning device 41, is guided via a first duct 18R and a second duct 18W to an air feed portion 19R disposed on the bottom surface of the illumination system barrel 6 of the illumination optical system ILS in the chamber 2 and to an air feed portion 19W disposed on the bottom surface of the optical system frame 16 respectively. The temperature control operation of the first local air-conditioning device 41 is controlled by an interference optical path air-conditioning control system 36 shown in FIG. 9. The air feed portions 19R, 19W are arranged on the optical paths for the measuring beams of a laser interferometer 21RY for the reticle stage RST, a laser interferometer 21WY for the wafer stage WST, etc., respectively. As shown in FIG. 12, the air feed portion 19R discharges the temperature-controlled airs ARY, ARX introduced from the duct 18R respectively at uniform wind velocity distributions in the down flow manner onto the optical paths 65Y, 65X for the measuring beams irradiated from the laser interferometers 21RY, 21RX onto the reticle stage RST. In FIG. 8, the airs ARY, ARX are collectively expressed as the air AR.

The air feed portion 19W shown in FIG. 8 discharges the temperature-controlled air AW guided from the duct 18W onto the optical path for the measuring beam at a uniform wind velocity distribution in the down flow manner. The airs AR, AW can be also discharged in the side flow manner. As a result, the positions of the reticle stage RST and the wafer stage WST can be measured highly accurately by the reticle interferometer 21R and the wafer interferometer 21W.

The third local air-conditioning device 143 is provided, which produces the two clean airs A28, A29 temperature-controlled at different accuracies from the compressed air incorporated from the compressed air supply tube 42 relatively highly accurately. The third local air-conditioning device 143 is provided with air supply ducts 44F, 44R in order to supply the airs A28, A29 respectively. In this case, the air A29 is supplied from the third local air-conditioning device 143 via the air supply duct 44R into the illumination system barrel 6 of the illumination optical system ILS. The air, which is allowed to flow through the illumination system barrel 6, is recovered, for example, via an unillustrated discharge duct to the gas recovery section of the main air-conditioning apparatus 8. Therefore, the end portion of the air supply duct 44R penetrates through the wall surface of the illumination system barrel 6. As shown in FIG. 8, a second condenser lens CL and an optical path-bending mirror ME which reflects the light beam from a first condenser lens (not shown) of the condenser optical system are accommodated in the illumination system barrel 6.

A cylindrical member 61, of which opening diameter is gradually decreased, is attached under or below the second condenser lens CL of the illumination system barrel 6. A hood portion 62 is fixed on the reticle stage RST so that the hood portion 62 is gradually widened to surround the reticle R. The cylindrical member 61 is arranged to surround the optical path for the illumination light EL. As shown in FIG. 12, the hood portion 62 includes a pair of flat plate-shaped hoods 62YA, 62YB which are gradually widened and which interpose the reticle R in the Y direction, and a pair of flat plate-shaped hoods 62XA, 62XB which are gradually widened and which interpose the reticle R in the X direction at the inside of the hoods 62YA, 62YB. FIG. 12 also shows the arrangement relationship among the hoods 62YA, 62YB, 62XA, 62XB, the reticle stage RST, and the reticle interferometer 21R. With reference to FIG. 12, the laser interferometer 21RY radiates or irradiates the measuring beams onto movement mirrors 21MY constructed of retroreflectors arranged in the reticle stage RST at two positions at the end in the +Y direction of the reticle stage RST, and the laser interferometer 21RX irradiates the measuring beam having a plurality of axes onto a rod-shaped movement mirror 21MX fixed at the end in the +X direction of the reticle stage RST. The laser interferometers 21RX, 21RY measure the positions in the X direction and the Y direction of the reticle stage RST at a plurality of places, for example, based on a reference mirror (not shown) disposed on a side surface of the projection optical system PL as a reference; and the laser interferometers 21RX, 21RY supply the measured values via the main controller 20 shown in FIG. 9 to the reticle stage-driving system 22R. It is allowable to use reflecting surfaces disposed on the side surfaces of the reticle stage RST, instead of the movement mirrors 21MY, 21MX.

In the structure shown in FIG. 12, even when the reticle stage RST is reciprocatively moved in the Y direction during the scanning exposure, the opening of the lower end of the cylindrical member 61 is moved over or above a rectangular area surrounded by the upper ends of the four hoods 62YA, 62YB, 62XA, 62XB. A rectangular cutout 61a is formed at the upper end in the −Y direction of the cylindrical member 61.

With reference to FIG. 8 again, the air A28, which is temperature-controlled highly accurately, is supplied from or via the cutout 61a of the cylindrical member 61 (see FIG. 12) via the air supply duct 44F from the third local air-conditioning device 143. The air A28 flows from the interior of the cylindrical member 61 to the hood portion 62 disposed at the upper surface of the reticle R in the down flow manner. After that, the air A28 is made to outflow to the outside from the gaps of the hoods 62YA, 62YB, 62XA, 62XB as shown by arrows 64A to 64D in FIG. 12, and the air A28 flows toward the floor FL. After that, the air A28 is recovered by the gas recovery section of the main air-conditioning apparatus 8.

The preset temperatures (target temperatures) of the airs A28, A29 are set to be same as the preset temperature (for example, a predetermined temperature within a range of 20 to 25° C.) of the air supplied into the chamber 2 from the main air-conditioning apparatus 8 in accordance with the downflow. However, the allowable range of the air A29 is set to be narrower than the allowable range (control accuracy) for the preset temperature of the air supplied from the main air-conditioning apparatus 8 in accordance with the downflow. The allowable range of the temperature of the air A28 is set to be narrower than the allowable range of the temperature of the air A29. Accordingly, the temperature of the optical path for the illumination light EL is maintained to be within the preset range highly accurately. Further, any minute foreign matter, which is present on the upper surface of the reticle R, is removed together with the air A28. The operation of the third local air-conditioning device 143 is controlled by the local air-conditioning control system 137 shown in FIG. 9.

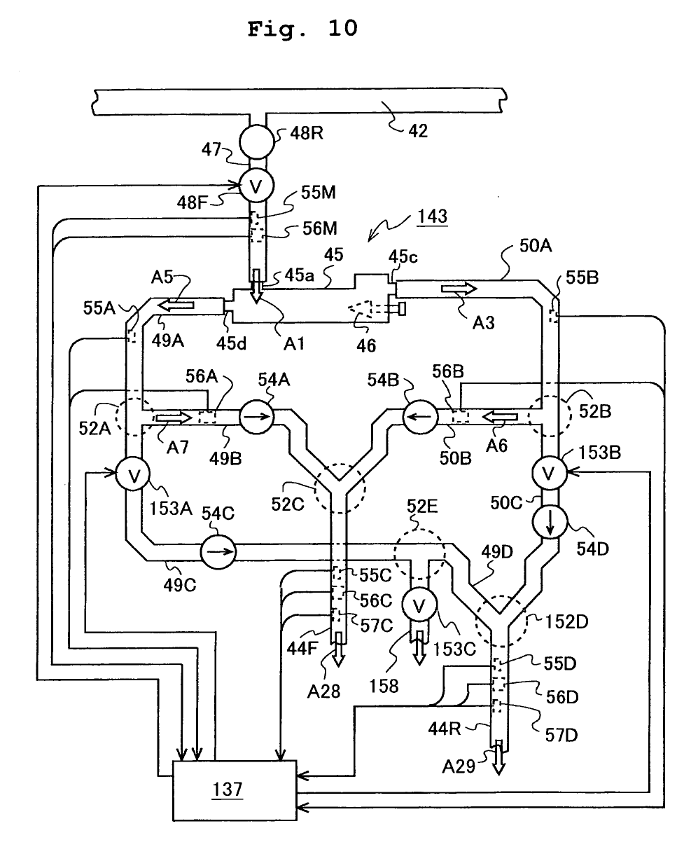

The construction of the third local air-conditioning device 143 will be explained in detail below with reference to FIG. 10. FIG. 10 shows a block diagram illustrating the construction of the third local air-conditioning device 143.

With reference to FIG. 10, the third local air-conditioning device 143 is provided with a vortex tube 45 connected to the compressed air supply tube 42 via a piping 47. The vortex tube 45 is the same as that used in the first embodiment as shown in FIG. 4. A regulator 48R for smoothing the pressure and a main flow rate control valve 48F for controlling the flow rate are arranged in the piping 47 at intermediate positions of the piping 47. Pipings 49A, 50A are connected to the vortex tube 45. A pressure sensor (barometer) may be arranged instead of the regulator 48R. The vortex tube 45 includes a supply port 45a to which the compressed air A1 is supplied from the compressed air supply tube 42 via the piping 47, a discharge port 45c through which a warm gas or warm air A3 having a temperature higher than that of the compressed air A1 is discharged to the piping 50A, a discharge port 45d through which a cool gas or cool air A5 having a temperature lower than that of the compressed air A1 is discharged to the piping 49A, and a throttle valve 46 which controls the flow rate ratio between the warm air A3 and the cool air A5 and the temperature of the cool air A5.

The cool air A5 in the piping 49A is supplied while being branched to pipings 49B, 49C via a T-shaped joint 52A, and the warm air A3 in the piping 50A is supplied while being branched to pipings 50B, 50C via a T-shaped joint 52B. Further, the cool air A7 in the piping 49B and the warm air A6 in the piping 50B are mixed with each other by a Y-shaped joint 52C, and the mixture is supplied to the air supply duct 44 as the temperature-controlled air A28 which is a first mixed gas. The cool air in the piping 49C is supplied while being branched to a piping 49D and a piping 158 by a T-shaped joint 52E. The cool air in the piping 49D and the warm air in the piping 50D are mixed with each other by a Y-shaped joint 152D, and the mixture is supplied to an air supply duct 44R as the temperature-controlled air A29 which is a second mixed gas. The temperature-controlled airs A28, A29 in the air supply ducts 44F, 44R are blown into the cylindrical member 61 and the illumination system barrel 6 shown in FIG. 8 respectively. The cool air in the piping 158 is supplied, for example, to the main air-conditioning apparatus 8, and the air is utilized as the air-conditioning air.

First and second flow rate control valves 153A, 153B are arranged in the pipings 49B, 50B at intermediate positions of the pipings 49B, 50B. A third flow rate control valve 153C is arranged in the piping 158 at an intermediate position of the piping 158. Check valves 54A, 54B are arranged in the pipings 49B, 50B at intermediate positions of the pipings 49B, 50B in order to avoid any reverse flow of the gas from the Y-shaped joint 52C. Similarly, check valves 54C, 54D are arranged in the pipings 49C, 50C at intermediate positions of the pipings 49C, 50C in order to avoid any reverse flow of the gas from the Y-shaped joint 152D.

Further, a temperature sensor 55M and a flow rate sensor 56M measuring the temperature and the flow rate of the compressed air A1 are arranged in the piping 47. Temperature sensors 55A, 55B measuring the temperatures of the cool air A5 and the warm air A3 are arranged in the pipings 49A, 50A respectively. Flow rate sensors 56A, 56B measuring the flow rates of the cool air A7 and the warm air A6 respectively are arranged in the pipings 49B, 50B. Further, a temperature sensor 55C, a flow rate sensor 56C, and a pressure sensor 57C measuring the temperature, the flow rate, and the pressure respectively of the air A28 are arranged in the air supply duct 44F. A temperature sensor 55D, a flow rate sensor 56D, and a pressure sensor 57D measuring the temperature, the flow rate, and the pressure respectively of the air A29 are arranged in the air supply duct 44R.

Measured values of the temperature sensors 55M, 55A to 55D, the flow rate sensors 56M, 56A to 56D, and the pressure sensors 57C, 57D are supplied to the local air-conditioning control system 137. The local air-conditioning control system 137 controls the opening degrees (0 to 100%) of the main flow rate control valve 48F and the flow rate control valves 153A to 153C based on the measured values and the control information (the preset temperature and the preset flow rate of the air A28, the preset temperature of the air A29, etc.) supplied from the main controller 20. The local air-conditioning control system 137 may further perform the control of the air pressure supplied from the regulator 48R and/or the throttle valve 46 of the vortex tube 45 (control of the flow rate and the temperature of the cool air A5). The third local air-conditioning device 143 is constructed to include the vortex tube 45, the pipings 47, 49A to 49D, 50A to 50C, 158, the regulator 48R, the main flow rate control valve 48F, the T-shaped joints 52A, 52B, 52E, the Y-shaped joint 52C, 152D, the flow rate control valves 153A to 153C, the check valves 54A to 54D, the air supply ducts 44F, 44R, the temperature sensors 55M, 55A to 55D, the flow rate sensors 56M, 56A to 56D, and the pressure sensors 57C, 57D as described above.

The flow rate control valves 153A, 153B may be arranged, for example, in the pipings 49B, 50B.

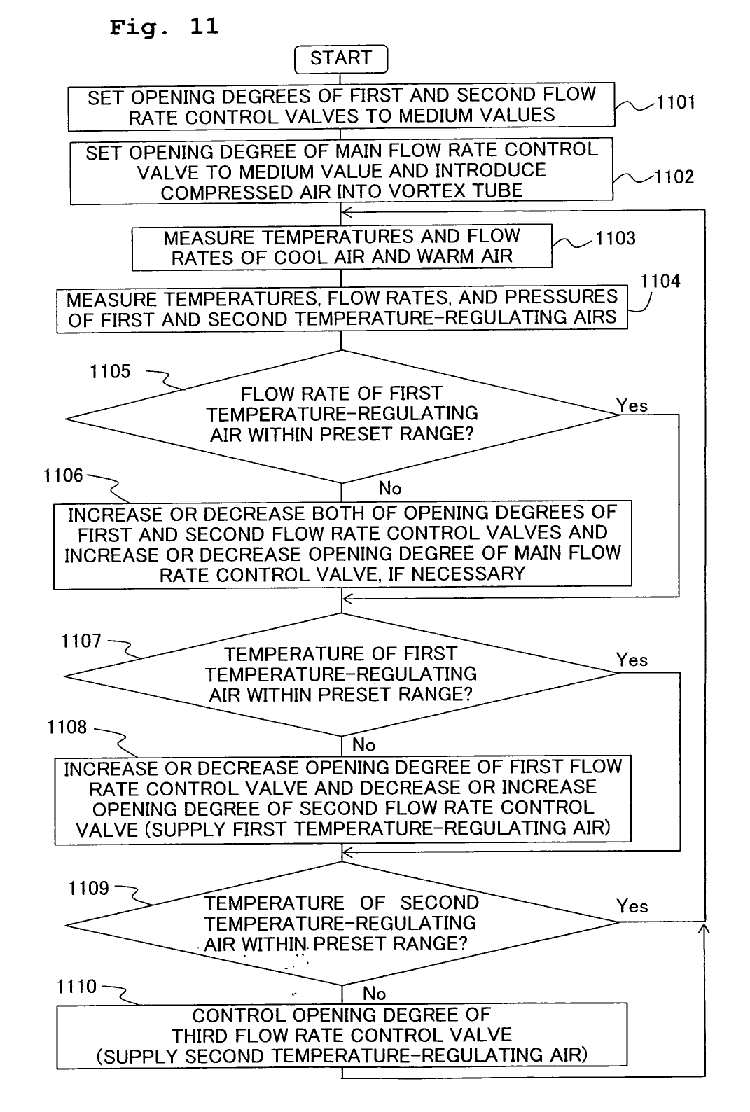

Next, an example of the air-conditioning operation of the third local air-conditioning device 143 shown in FIG. 10 will be explained with reference to a flow chart shown in FIG. 11. This operation is executed concurrently with the exposure operation of the exposure apparatus 10, and this operation is controlled by the local air-conditioning control system 137. In this procedure, the following assumption is affirmed. That is, the air, which is outputted from the regulator 48R, has a pressure which is set to be, for example, about three to five times the atmospheric pressure; and that the throttle valve 46 of the vortex tube 45 is adjusted so that the cool air A5 has a lower temperature and the warm air A3 has a higher temperature as compared with the preset temperature (for example, a predetermined temperature within a range of 20 to 25° C.) of the airs A28, A29 shown in FIG. 8. As an example, the preset flow rate of the air A28 is set to be smaller than the flow rate of the compressed air A1 to be obtained when the opening degree of the main flow rate control valve 48F is set in the vicinity of the median or medium value (50%).

At first, in Step 1101 shown in FIG. 11, the opening degrees of the first and second flow rate control valves 153A, 153B are set, for example, to the medium values. The opening degree of the third flow rate control valve 153C is set, for example, to a small value (for example, about 10%). Subsequently, in Step 1102, the opening degree of the main flow rate control valve 48F is set, for example, to the medium value, and the compressed air A1 is introduced from the compressed air supply tube 42 via the piping 47 into the vortex tube 45. Accordingly, from the vortex tube 45, the cool air A5 is supplied to the piping 49A and the warm air A3 is supplied to the piping 50A. The cool air A7, which is branched from the piping 49A to the piping 49B, is mixed by the Y-shaped joint 52C with the warm air A6 which is branched from the piping 50A to the piping 50B, and the mixture is supplied as the air A28 to the air supply duct 44. During this process, the cool air passing through the piping 49D and the warm air passing through the piping 50C are mixed with each other, and the mixture is supplied as the air A29 to the air supply duct 44R. The cool air, which is supplied from the flow rate control valve 153C toward the piping 158, is recovered.

Subsequently, the temperatures and the flow rates of the cool air A5 (A7) and the warm air A3 (A6) are measured by the temperature sensors 55A, 55B and the flow rate sensors 56A, 56B, and the measured values are supplied to the local air-conditioning control system 137 (Step 1103). Further, the temperatures, the flow rates, and the pressures of the air A28 (first temperature-regulating air) in the air supply duct 44F and the air A29 (second temperature-regulating air) in the air supply duct 44R are measured by the temperature sensors 55C, 55D, the flow rate sensors 56C, 56D, and the pressure sensors 57C, 57D respectively, and the measured values are supplied to the local air-conditioning control system 137 (Step 1104).

After that, the local air-conditioning control system 137 judges whether or not the measured flow rate of the air A28 is within a preset allowable range (preset range) with respect to the preset value supplied from the main controller 20 (Step 1105). If the flow rate is within the preset range, the operation proceeds to Step 1107. If the flow rate is not within the preset range, the operation proceeds to Step 1106.

In Step 1106, if the flow rate of the air A28 is less than the preset range, then the local air-conditioning control system 137 decreases the opening degrees of the first and second flow rate control valves 153A, 153B by a first control amount (for example, several %). Accordingly, both of the flow rates of the cool air A7 and the warm air A6 are increased, and the flow rate of the air A28 is increased. The flow rates of the cool air A7 and the warm air A6 have been measured in Step 1103. Therefore, the opening degrees of the flow rate control valves 153A, 153B may be decreased by an amount corresponding to ½ of the difference between the preset value and the total value of the measured values. On the other hand, if the flow rate of the air A28 is more than the preset range, then the opening degrees of the flow rate control valves 153A, 153B are increased, for example, by the first control amount, to thereby decrease the flow rates of the cool air A7 and the warm air A6.

If the opening degree of at least one of the flow rate control valves 153A, 153B arrives at a predetermined lower limit (for example, about 10%) or an upper limit (for example, 90%) in Step 1106 after repeating the operations ranging from Step 1103 to Step 1108 many times, the opening degree of the main flow rate control valve 48F may be increased or decreased by a predetermined amount respectively.

Subsequently, in Step 1107, the local air-conditioning control system 137 judges whether or not the measured temperature of the air A28 (first temperature-regulating air) is within a preset allowable range (preset range) with respect to the preset value supplied from the main controller 20. If the temperature is within the preset range, the operation proceeds to Step 1109. If the temperature is not within the preset range, the operation proceeds to Step 1108.

In Step 1108, if the temperature of the air A28 is lower than the preset range, then the local air-conditioning control system 137 increases the opening degree of the first flow rate control valve 153A by a second predetermined amount (for example, several %), and the local air-conditioning control system 137 decreases the opening degree of the second flow rate control valve 153B so that the amount of decrease in the flow rate of the air A28 brought about thereby is supplemented. In accordance with the control of the mixing ratio between the cool air A7 and the warm air A6, the ratio of the cool air A7 included in the air A28 is decreased and the temperature of the air A28 is raised, although the flow rate of the air A28 is not changed.

On the other hand, if the temperature of the air A28 is higher than the preset range, then the opening degree of the flow rate control valve 153A is decreased by the second predetermined amount, and the opening degree of the flow rate control valve 153B is increased so that the amount of increase in the flow rate of the air A28 brought about thereby is offset. Accordingly, the ratio of the cool air A7 included in the air A28 is increased and the temperature of the air A28 is lowered, although the flow rate of the air A28 is not changed. It is allowable to use a control amount of the flow rate itself, instead of the second control amount.

Subsequently, in Step 1109, the local air-conditioning control system 137 judges whether or not the measured temperature of the air A29 (second temperature-regulating air) is within a preset allowable range (preset range) with respect to the preset value supplied from the main controller 20. The preset range of the temperature of the air A29 is set to be wider than the preset range of the temperature of the air A28. If the temperature is within the preset range, the operation returns to Step 1103 to repeat the operations of Steps 1103 to 1110. If the temperature is not within the preset range, the operation proceeds to Step 1110.

In Step 1110, if the temperature of the air A29 is lower than a preset range, the local air-conditioning control system 137 increases the opening degree of the third flow rate control valve 153C by a third predetermined amount (for example, about 1%). Accordingly, the ratio of the cool air included in the air A29 is decreased and the temperature of the air A29 is raised. On the contrary, if the temperature of the air A29 is higher than the preset range, it is appropriate that the opening degree of the flow rate control valve 153C is increased by the third predetermined amount. When this operation is repeated a plurality of times, the temperature of the air A29 can be also controlled to be within the preset range.

If there is such a tendency that the temperature of the air A29 passing through the air supply duct 44R is higher than the preset temperature when the opening degree of the flow rate control valve 153C is 0% (completely closed), then the T-shaped joint 52E may be arranged on the side of the piping 50C, and a part of the warm air in the piping 50C may be discharged. If the temperature of the air A29 is included within the preset range in a state that the opening degree of the flow rate control valve 153C is 0%, then the T-shaped joint 52E, the piping 158, and the flow rate control valve 153C may be omitted, and the operations of Steps 1109, 1110 may be omitted.

After that, the operation returns to Step 1103. The operations of Steps 1103 to 1110 are thereafter repeated until the main controller 20 issues the instruction to stop the air-conditioning to the local air-conditioning control system 137. In this procedure, the temperature of the cool air A5 discharged from the vortex tube 45 is lower than the preset temperature of the air A28, and the temperature of the warm air A3 is higher than the preset temperature. Therefore, by adjusting the mixing ratio between the cool air A7 and the warm air A6 in Step 1108, it is possible to easily control the temperature of the air A28 supplied to the air supply duct 44F shown in FIG. 8 within the preset range.

The function, the effect, etc. of the exposure apparatus 10 of this embodiment are as follows.

(1) The exposure method, which uses the exposure apparatus 10, is the exposure method for illuminating the reticle R with the illumination light EL to expose the wafer W with the illumination light EL via the pattern of the reticle R and the projection optical system PL, the exposure method including Step 1102 of injecting the compressed air A1 into the vortex tube 45 to generate the cool air A5 and the warm air A3; Step 1103 of separating the generated cool air A5 into the first cool air (cool air A7) and the second cool air and separating the generated warm air A3 into the first warm air (warm air A6) and the second warm air; Steps 1107, 1108 of controlling the flow rates of the cool air A7 and the warm air A3 based on the temperature of the air A28 (first temperature-regulating air) obtained by mixing the cool air A7 and the warm air A3; Step 1108 of supplying the air A28 into the cylindrical member 61 shown in FIG. 8; and Step 1110 of supplying the air A29 (second temperature-regulating air) obtained by mixing at least a part of the second cool air and the second warm air into the illumination system barrel 6 for which the target control accuracy of the temperature is lower than that in the cylindrical member 61.

The exposure apparatus 10 includes the local air-conditioning system including the third local air-conditioning device 143 and the local air-conditioning control system 137. The third local air-conditioning device 143 includes the vortex tube 45, the T-shaped joints 52A, 52B which separate the cool air A5 and the warm air A3 generated from the vortex tube 45 into the cool air A7 and the second cool air and into the warm air A6 and the second warm air respectively, the Y-shaped joint 152C which mixes the cool air A7 and the warm air A6, the Y-shaped joint 152D which mixes at least a part of the second cool air and the second warm air, the temperature sensor 55C which measures the temperature of the air A28 outputted from the Y-shaped joint 52C, the flow rate control valves 153A, 153B which control the flow rates of the cool air A7 and the warm air A6 based on the measured value obtained by the temperature sensor 55C, the air supply duct 44F which supplies the air A28 to the cylindrical member 61, and the air supply duct 44R which supplies the air A29 outputted from the Y-shaped joint 152D to the illumination system barrel 6.

Therefore, without using any refrigerant or any cooling medium, it is possible to perform the local temperature control at the two places in the chamber 2 by the simple mechanism by generating the cool air and the warm air from the compressed air with the vortex tube 45 and controlling the mixing ratio between the cool air and the warm air to generate the temperature-controlled air. As a result, it is possible to maintain the high exposure accuracy. The control accuracy of the temperature of the air A29 is set to be low as compared with the control accuracy of the temperature of the air A28. Therefore, it is appropriate that the flow rates of the cool air A7 and the warm air A6 are firstly controlled based on the temperature of the air A28 in the third local air-conditioning device 143, thereby making it possible to simplify the construction of the third local air-conditioning device 143.

Further, the compressed air supply tube 42 is generally provided in the semiconductor device production factory, etc. Therefore, the production cost of the third local air-conditioning device 143 can be suppressed to be low.

It is not necessarily indispensable that the gas, which is supplied to the vortex tube 45, is the compressed air. It is also allowable to use such a gas that the volume is decreased to some extent as compared with the ordinary gas.

(2) The exposure method further includes Steps 1105, 1106 of controlling the flow rates of the cool air A7 and the warm air A6 based on the measured value of the flow rate of the air A28. Therefore, the temperature and the flow rate of the air A28 can be controlled to be within the preset ranges.

(3) The air A28 supplied from the air supply duct 44F shown in FIG. 8 into the cylindrical member 61 flows to the space included in the hoods 62YA, 62YB, 62XA, 62XB provided to surround the reticle R on the reticle stage RST, and then the air A28 is discharged from the gaps of the hoods 62YA, 62YB, 62XA, 62XB as shown in FIG. 12. Therefore, the air A28 does not inhibit the flows of the temperature-controlled airs ARY, ARX supplied to the optical paths for the laser interferometers 21RY, 21RX. Therefore, it is possible to maintain the high measurement accuracies of the laser interferometers 21RY, 21RX.

(4) In this case, the air A28 is supplied in the down flow manner via the cutout 61a located between the illumination optical system ILS (illumination system barrel 6) and the cylindrical member 61. Therefore any minute foreign matter, etc. generated, for example, from the reticle R can be discharged toward the floor FL together with the air A28.

### Third Modification

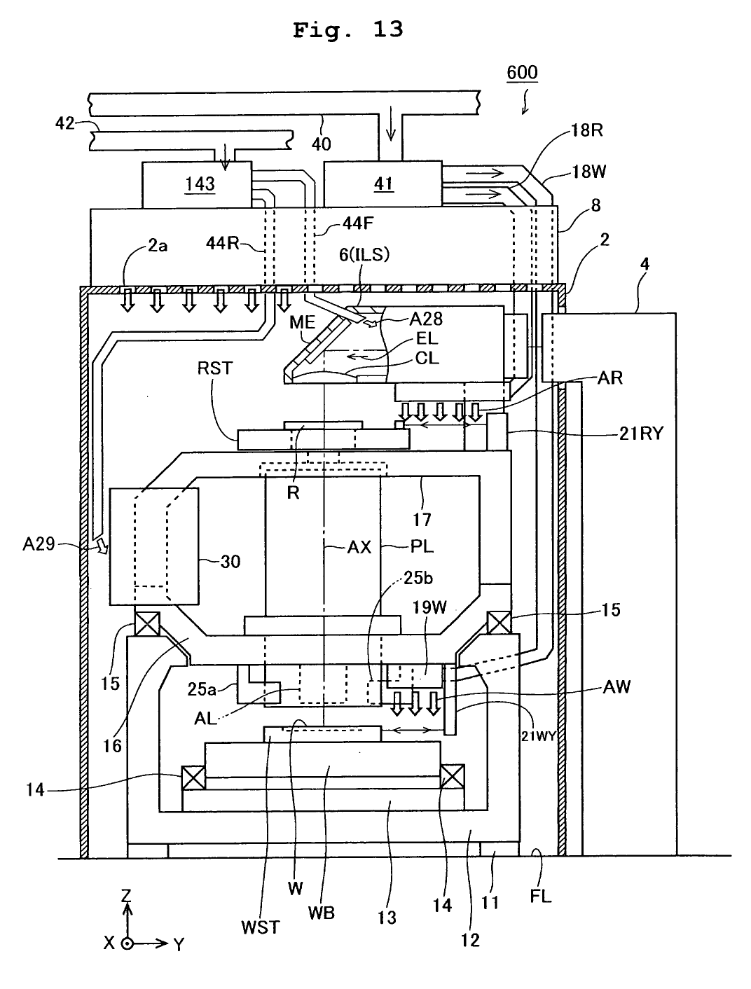

In the second embodiment, the temperature-controlled two airs A28, A29, which are supplied from the third local air-conditioning device 143, are supplied into the cylindrical member 61 and the illumination system barrel 6. However, the airs A28, A29 can be supplied to any other arbitrary area. For example, as shown in an exposure apparatus 600 of a modification shown in FIG. 13, the air A28 may be supplied from the third local air-conditioning device 143 via the air supply duct 44F into the illumination system barrel 6, and the air A29 may be blown, via the air supply duct 44R, against the outer surface of the control box 30 accommodating the heat sources. In this case, the control accuracy of the temperature of the air A28 supplied into the illumination system barrel 6 is set to be higher than the control accuracy of the temperature of the air A29 blown against the outer surface of the control box 30. This modification is same as or equivalent to the second embodiment except that the air A29 is blown against the outer surface of the control box 30. Therefore, the structure and the operation of the exposure apparatus are omitted from the explanation.

Further, one or both of the two airs A8, A9 generated from the second local air-conditioning device 43 in the first embodiment or the two airs A28, A29 generated from the third local air-conditioning device 143 in the second embodiment may be branched into two or more by using a branch tube or pipe. The branched air may be supplied to still another heat source including, for example, the laser light source or sources of the reticle interferometer 21R and/or the wafer interferometer 21W and the signal processing systems 26, 27 for the AF sensor 25 and/or the alignment system AL, in addition to the portions to which the airs A8, A9 are supplied in the first embodiment or the portions to which the airs A28, A29 are supplied in the second embodiment. The branched air may be also supplied to the reticle R which is thermally expanded by being irradiated with the illumination light EL. The portion, to which the air generated from the local air-conditioning system is supplied, is not limited to the above, which may be arbitrary.

### Third Embodiment

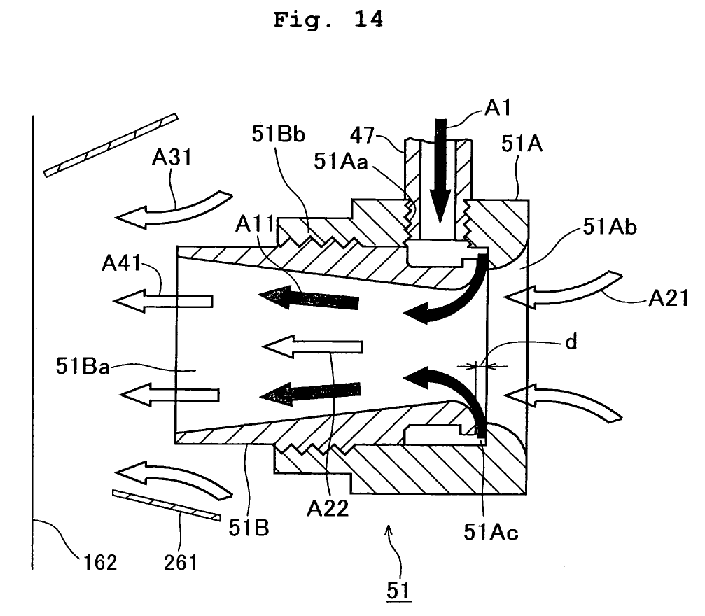

Next, a third embodiment of the present invention will be explained with reference to FIG. 14. In an exposure apparatus and an exposure method of this embodiment, the compressed air A1, which is supplied from the compressed air supply tube 42 shown in FIG. 10, is amplified by using an air-amplifying technique.

FIG. 14 is a sectional view of main components of a local air-conditioning device (fourth local air-conditioning device) of this embodiment. With reference to FIG. 14, the compressed air A1, which is incorporated via the piping 47 from the compressed air supply tube 42 shown in FIG. 10, is supplied to an injection port 51Aa of an air-amplifying member 51. The air-amplifying member 51 includes a cylindrical outer cylinder 51A and a cylindrical inner cylinder 51B which are screw-engaged and connected to each other at a screw portion 51Bb. The injection port 51Aa is formed on a side surface of the outer cylinder 51A. The end of the outer cylinder 51A, which is different from the screw portion 51Bb, is an external air suction port 51Ab. A groove portion 51Ac, which is communicated with the injection port 51Aa and which has a variable width d, is formed between the end of the inner cylinder 51B and a stepped portion included in the outer cylinder 51A and located in the vicinity of the external air suction port 51Ab. The width of the groove portion 51Ac can be adjusted by adjusting the width of the screw engagement between the outer cylinder 51A and the inner cylinder 51B.

A blow port 51Ba is disposed at the end of the inner cylinder 51B opposite to or facing the external air suction port 51Ab. A temperature control objective 162 is arranged with an intervening air feed duct 261 so that the temperature control objective 162 is opposite to or facing the blow port 51Ba. The temperature control objective 162 is, for example, the light source section 4 or the control box 30 accommodating the heat sources shown in FIG. 8. Other than the above, the exposure apparatus is constructed in the same manner as in the embodiments shown in FIGS. 1 and 8.

In this embodiment, when the temperature control objective 162 is locally cooled, the compressed air A1 is injected into the injection port 51Aa of the air-amplifying member 51 shown in FIG. 14 via the piping 47 (with the regulator 48R and the main flow rate control valve 48F arranged at the intermediate positions thereof) from the compressed air supply tube 42 shown in FIG. 10. The injected compressed air A1 is jetted via the groove portion 51Ac (slit portion) into the inner cylinder 51B as shown by arrows A11. Surrounding air A21 is sucked from the external air suction port 51Ab into the inner cylinder 51B as shown by arrows A22 by the negative pressure formed upon the jetting, and the flow rate of the compressed air A1 is substantially increased (amplifying step).

An air A41 obtained by combining the compressed air A1 and the surrounding air A21 is made to flow through the air feed duct 261, and the air A41 is fed to the temperature control objective 162 (supplying step). Therefore, it is possible to perform the local temperature control by the simple mechanism without using any refrigerant. Further, by using the air-amplifying member 51, it is possible to perform the temperature control or the cooling more efficiently as compared with such a case that the compressed air A1 incorporated from the compressed air supply tube 42 via the piping 47 is directly blown against the temperature control objective 162. In this procedure, an air A31, which is present outside the end portion of the inner cylinder 51B, is also fed to the temperature control objective 162 by being induced or guided by the flow of the air A41. Therefore, the efficiency is further improved for the temperature control or the cooling.

In this embodiment, the width d of the groove portion 51Ac of the air-amplifying member 51 may be adjusted so that the efficiency of the temperature control of the temperature control objective 162 is maximized (for example, so that the temperature increase range is minimized within a predetermined time).

In the embodiments described above, the temperature control or the cooling is performed by using the compressed air incorporated from the compressed air supply tube 42. However, the temperature control or the cooling may be performed by using a compressed air generated by using, for example, a compressor, a regulator, and a dustproof filter.

The foregoing embodiments have been explained as exemplified by the exposure apparatus having the first local air-conditioning device 41 and the second local air-conditioning device 43 or the third local air-conditioning device 143 by way of example. However, in view of the object of the present invention, it is also possible to omit the first local air-conditioning device. In this case, the air, which is temperature-controlled by the second local air-conditioning device or the third local air-conditioning device, may be supplied to the place to which the air, which is temperature-controlled by the first local air-conditioning device, has been supplied. Alternatively, the air-conditioning device (the second air-conditioning device or the third local air-conditioning device), which uses the vortex tube as explained with reference to FIG. 3 or FIG. 10, may be adopted as the first local air-conditioning device, without omitting the first local air-conditioning device.

In the embodiments described above, the air (for example, the dry air) is used as the gas for the air-conditioning. However, in place of the air, it is also allowable to use an inert gas such as nitrogen gas or rare gas or noble gas (helium, neon, etc.) or any mixed gas of the gases as described above, etc. It is also allowable that the gas, which is supplied to the vortex tube as described above, is not the compressed gas (air). It is also allowable to use such a gas that the volume is decreased to some extent as compared with the ordinary gas.

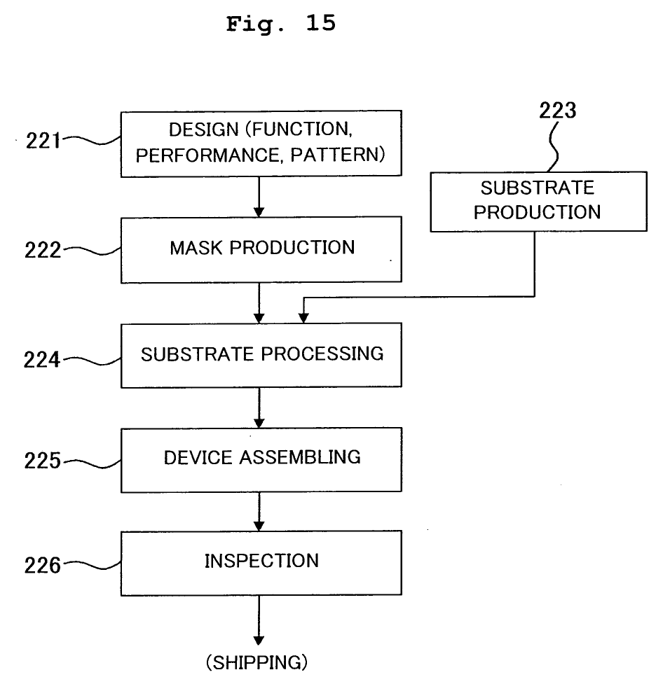

When an electronic device such as a semiconductor device (or a microdevice) is produced by using the exposure apparatus or the exposure method of the embodiment described above, as shown in FIG. 15, the electronic device is produced by performing a step 221 of designing the function and the performance of the electronic device; a step 222 of manufacturing a mask (reticle) based on the designing step; a step 223 of producing a substrate (wafer) as a base material for the device and coating the substrate (wafer) with the resist; a substrate-processing step 224 including a step of exposing the substrate (photosensitive substrate) with the pattern of the mask by the exposure apparatus or the exposure method of the embodiment described above, a step of developing the exposed substrate, a step of heating (curing) and etching the developed substrate, etc.; a step 225 of assembling the device (including processing processes such as a dicing step, a bonding step, and a packaging step); an inspection step 226; and the like.

Therefore, the method for producing the device includes forming the pattern of the photosensitive layer on the substrate by using the exposure apparatus or the exposure method of the embodiment described above, and processing the substrate formed with the pattern (Step 224). According to the exposure apparatus or the exposure method, it is possible to perform the temperature control for the exposure apparatus while lowering the maintenance frequency by using the compressed air. Therefore, the electronic device can be produced inexpensively and highly accurately.

The present invention is not limited only to the projection exposure apparatus of the scanning exposure type. The present invention is also applicable to a case that the exposure is performed by using a projection exposure apparatus of the full field exposure type (stepper type). The present invention is also applicable to a case that the exposure is performed by using, for example, an exposure apparatus of the proximity system or the contact system in which the projection optical system is not used.

The present invention is also applicable to a case that the exposure apparatus (lithography system) is used to project the image of the line-and-space pattern on the wafer by forming the interference fringes on the wafer as disclosed, for example, in International Publication No. 2001/035168.

The present invention is not limited to the application to the production process for the semiconductor device. The present invention is also widely applicable, for example, to the production process for the display apparatus including, for example, a liquid crystal display element formed on a rectangular glass plate and a plasma display as well as to the production process for various devices including an image pickup element (CCD, etc.), a micromachine, MEMS (Microelectromechanical Systems), a thin film magnetic head, a DNA chip, and the like. Further, the present invention is also applicable to the production step of producing a mask (a photomask, a reticle, etc.) formed with mask patterns of various devices by using the photolithography step, and the like.

The present invention is also applicable to a multi-stage type exposure apparatus provided with a plurality of stages as disclosed, for example, in Japanese Patent Application Laid-open No. 10-163099 (and U.S. Pat. No. 6,590,634 corresponding thereto), Published Japanese Translation of PCT International Publication for Patent Application No. 2000-505958 (and U.S. Pat. No. 5,969,441 corresponding thereto), and U.S. Pat. No. 6,208,407; and an exposure apparatus provided with a measuring stage having a measuring member (a reference mark, a sensor, etc.) as disclosed, for example, in Japanese Patent Application Laid-open No. 11-135400 (and International Publication No. 1999/23692 corresponding thereto) and Japanese Patent Application Laid-open No. 2000-164504 (and U.S. Pat. No. 6,897,963 corresponding thereto).

In the respective embodiments described above, the positions of the reticle stage RST and the wafer stage WST are measured by the interferometer systems respectively. However, there is no limitation to this. At least one of the positions of the reticle stage RST and the wafer stage WST may be measured by the encoder system disclosed, for example, in United States Patent Application Publication No. 2007/0288121.

In the respective embodiments described above, the reticle (light-transmissive mask), in which the predetermined light shielding pattern is formed on the light-transmissive substrate, is used. However, instead of such a light-transmissive mask, it is also allowable to use, for example, an electronic mask (variably shaped mask) for forming a transmissive pattern, a reflective pattern, or a light-emitting pattern based on the electronic data of the pattern to be subjected to the exposure.

The disclosures of the respective published patent documents, respective International Publications, United States patents, and United States patent application Publications are incorporated herein by reference.

It is a matter of course that the present invention is not limited to the embodiments described above, and may be embodied in other various forms without deviating from the gist or essential characteristics of the present invention.

The exposure method and the exposure apparatus of the present invention make it possible to perform the exposure while performing the local temperature control or the local cooling by the simple mechanism without using any refrigerant or any cooling medium such as fron. Therefore, the exposure method and the exposure apparatus of the present invention are excellent in the environmental performance and the production cost. Therefore, the present invention can remarkably contribute to the international development of the precision mechanical equipment industry such as the semiconductor industry using the exposure technique.

What is claimed is:

1. An exposure method for illuminating a pattern with an exposure light to expose an object with the exposure light via the pattern, the exposure method comprising:
injecting a gas into a vortex tube;
adjusting a mixing ratio between a cool gas and a warm gas generated from the vortex tube to produce a temperature-controlled gas; and
supplying the temperature-controlled gas to a heat source or a vicinity of the heat source.

2. The exposure method according to claim 1, wherein the gas, which is injected into the vortex tube, is a compressed gas.

3. The exposure method according to claim 1, wherein the adjusting the mixing ratio between the cool gas and the warm gas generated from the vortex tube to produce the temperature-controlled gas includes adjusting flow rates and mixing ratios of the cool gas and the warm gas respectively.

4. The exposure method according to claim 1, wherein the supplying the gas includes blowing the temperature-controlled gas against the heat source or a member which accommodates the heat source.

5. The exposure method according to claim 1, wherein the supplying the gas includes supplying the temperature-controlled gas to a heat sink which is arranged in the vicinity of the heat source.

6. The exposure method according to claim 1, wherein the supplying the gas includes supplying the temperature-controlled gas to a second chamber which is arranged adjacently to a first chamber including the heat source, with a partition wall intervening between the first and second chambers.

7. The exposure method according to claim 6, wherein the supplying the gas includes mixing and discharging the gas flowed through the first chamber and the gas flowed through the second chamber.

8. The exposure method according to claim 1, wherein the temperature-controlled gas is supplied to the heat source or the vicinity thereof during a period in which the object is exposed with the exposure light via the pattern.

9. The exposure method according to claim 1, further comprising separating the cool gas and the warm gas generated from the vortex tube into first and second cool gases and first and second warm gases respectively;
controlling flow rates of the first cool gas and the first warm gas based on temperature information of a first gas obtained by mixing the first cool gas and the first warm gas;
supplying the first gas to a first temperature control area; and
supplying a second gas obtained by mixing at least a part of the second cool gas and at least a part of the second warm gas to a second temperature control area which is different from the first temperature control area.

10. An exposure apparatus which illuminates a pattern with an exposure light and exposes an object with the exposure light via the pattern, the exposure apparatus comprising:
a vortex tube which generates a cool gas and a warm gas from a compressed gas injected from a compressed gas source;
a gas mixing section which mixes the cool gas and the warm gas generated from the vortex tube at a variable mixing ratio to output a temperature-controlled gas; and
a gas supply passage which supplies the temperature-controlled gas to a heat source or a vicinity of the heat source.

11. The exposure apparatus according to claim 10, further comprising:
a temperature sensor which measures temperature information of the gas mixed at the variable mixing ratio; and
a controller which controls the mixing ratio for the gas mixing section based on the information measured by the temperature sensor.

12. The exposure apparatus according to claim 11, wherein the gas mixing section includes a first flow rate controller which controls a flow rate of the cool gas, a second flow rate controller which controls a flow rate of the warm gas, and a mixing section which mixes the gases outputted from the first and second flow rate controllers;
the exposure apparatus further comprises a flow rate sensor which measures flow rate information of the gas to be mixed in the mixing section; and
the controller controls the flow rates of the gases in the first and second flow rate controllers based on the information measured by the temperature sensor and the flow rate sensor.

13. The exposure apparatus according to claim 10, wherein a blow port of the gas supply passage is arranged to face an interior of the heat source or a member which accommodates the heat source.

14. The exposure apparatus according to claim 10, further comprising a heat sink which is arranged in the vicinity of the heat source;
wherein a blow port of the gas supply passage is connected to the heat sink.

15. The exposure apparatus according to claim 10, further comprising a first chamber which includes the heat source, and a second chamber which is disposed adjacently to the first chamber with a partition wall intervening therebetween;
wherein the gas passed through the gas supply passage is supplied to the second chamber.

16. The exposure apparatus according to claim 15, further comprising a discharge passage which mixes and discharges the gas flowed through the first chamber and the gas flowed through the second chamber.

17. The exposure apparatus according to claim 10, further comprising an exposure apparatus-body and a chamber which accommodates the exposure apparatus-body; wherein the heat source is a part of the exposure apparatus-body accommodated in the chamber.

18. The exposure apparatus according to claim 17, further comprising an air-conditioning apparatus which supplies a temperature-controlled gas into the chamber, wherein the controller controls a temperature of the gas outputted from the gas mixing section so that the temperature is lower than a temperature of the gas supplied from the air-conditioning apparatus.

19. The exposure apparatus according to claim 17, wherein the vortex tube and the gas mixing section are provided outside the chamber.

20. The exposure apparatus according to claim 10, further comprising first and second separating sections which separate the cool gas and the warm gas generated from the vortex tube into first and second cool gases and first and second warm gases respectively; a first mixing section which mixes the first cool gas and the first warm gas; a second mixing section which mixes at least a part of the second cool gas and at least a part of the second warm gas; a temperature sensor which measures temperature information of a first gas outputted from the first mixing section; a controller which controls flow rates of the first cool gas and the first warm gas based on the information measured by the temperature sensor; a first gas supply passage which supplies the first gas to a first temperature control area; and a second gas supply passage which supplies a second gas outputted from the second mixing section to a second temperature control area different from the first temperature control area.

21. The exposure apparatus according to claim 10, wherein the gas supply passage is constructed so that the temperature-controlled gas is locally supplied to an optical path for the exposure light coming into the pattern.

22. An exposure method for illuminating a pattern with an exposure light to expose an object with the exposure light via the pattern, the exposure method comprising:
injecting a gas into a vortex tube;
separating a cool gas and a warm gas generated from the vortex tube into first and second cool gases and first and second warm gases respectively;
controlling flow rates of the first cool gas and the first warm gas based on temperature information of a first gas obtained by mixing the first cool gas and the first warm gas;
supplying the first gas to a first temperature control area; and
supplying a second gas obtained by mixing at least a part of the second cool gas and at least a part of the second warm gas to a second temperature control area for which a target temperature control accuracy is lower than that of the first temperature control area.

23. The exposure method according to claim 22, wherein the controlling includes controlling the flow rates of the first cool gas and the first warm gas based on the temperature information and flow rate information of the first gas.

24. The exposure method according to claim 22, wherein the first temperature control area includes an area on a mask formed with the pattern; and
the second temperature control area is an area including at least a part of an optical path of an illumination optical system which illuminates the pattern with the exposure light.

25. The exposure method according to claim 24, wherein the first temperature control area includes an area surrounded by a partition wall portion which is provided at a light-exit end of the illumination optical system for the exposure light and a hood member which is provided at a side of the illumination optical system of the mask.

26. The exposure method according to claim 25, wherein the supplying the first gas to the first temperature control area includes supplying the first gas to an interior of the partition wall portion in a downflow manner from a space between the illumination optical system and the partition wall portion.

27. The exposure method according to claim 22, further comprising controlling a flow rate of the second cool gas based on temperature information of the second gas.

28. The exposure method according to claim 22, wherein the first gas and the second gas, which are temperature-controlled, are each supplied to the second temperature control area different from the first temperature control area, during a period in which the object is exposed with the exposure light via the pattern.

29. An exposure apparatus which illuminates a pattern with an exposure light and exposes an object with the exposure light via the pattern, the exposure apparatus comprising:
a vortex tube which generates a cool gas and a warm gas from a gas injected from a gas source into the vortex tube;
first and second separating sections which separate the cool gas and the warm gas generated from the vortex tube into first and second cool gases and first and second warm gases, respectively;
first and second mixing sections which mix the first cool gas and the first warm gas and which mix at least a part of the second cool gas and at least a part of the second warm gas, respectively;
a temperature sensor which measures temperature information of a first gas outputted from the first mixing section;
a controller which controls flow rates of the first cool gas and the first warm gas based on the information measured by the temperature sensor;
a first gas supply passage which supplies the first gas to a first temperature control area; and
a second gas supply passage which supplies a second gas outputted from the second mixing section to a second temperature control area having a target temperature control accuracy lower than that of the first temperature control area.

30. The exposure apparatus according to claim 29, further comprising a flow rate sensor which measures flow rate information of the first gas;
wherein the controller controls the flow rates of the first cool gas and the first warm gas based on the information measured by the temperature sensor and the flow rate sensor.

31. The exposure apparatus according to claim 29, further comprising an illumination optical system which illuminates the pattern with the exposure light, the first temperature control area including an area on a mask formed with the pattern;
wherein the second temperature control area is an area which includes at least a part of an optical path of the illumination optical system.

32. The exposure apparatus according to claim 31, further comprising a partition wall portion which is provided at a light-exit end of the illumination optical system for the exposure light and a hood member which is provided at a side of the illumination optical system of the mask; wherein the first temperature control area includes an area surrounded by the partition wall portion and the hood member.

33. The exposure apparatus according to claim 32, wherein a blow port of the first gas supply passage is arranged between the illumination optical system and the partition wall portion.

34. The exposure apparatus according to claim 29, further comprising an exposure apparatus-body and a chamber which accommodates the exposure apparatus-body; wherein the first temperature control area and the second temperature control area are parts of the exposure apparatus-body accommodated in the chamber.

35. The exposure apparatus according to claim 29, further comprising an air-conditioning apparatus which supplies a temperature-controlled gas into the chamber; wherein the controller controls a temperature of the gas outputted from the gas mixing section so that the temperature is lower than a temperature of the gas supplied from the air-conditioning apparatus.

36. The exposure apparatus according to claim 35, further comprising an air-conditioning controller which performs local air-conditioning control for a portion different from the first temperature control area and the second temperature control area in the chamber.

37. An exposure method for illuminating a pattern with an exposure light to expose an object with the exposure light via the pattern, the exposure method comprising:
generating a gas having an increased flow rate with a suction of a surrounding gas surrounding a slit portion by a negative pressure obtained when a compressed gas is jetted through the slit portion; and
supplying the gas having the increased flow rate to a heat source or a vicinity of the heat source.

38. The exposure method according to claim 37, wherein the gas having the increased flow rate is supplied to the heat source or the vicinity of the heat source during a period in which the object is exposed with the exposure light via the pattern.

39. A method for producing a device, comprising:
forming a pattern of a photosensitive layer on a substrate by using the exposure method as defined in claim 1; and
processing the substrate formed with the pattern.

40. An exposure apparatus which illuminates a pattern with an exposure light and exposes an object with the exposure light via the pattern, the exposure apparatus comprising:
a piping which guides a compressed gas from a compressed gas source;
a gas-amplifying section including an injection port into which the compressed gas is injected via the piping, a groove portion which is communicated with the injection port, an outside gas suction port which is provided adjacently to the groove portion, and a blow port from which a gas outflowed from the groove portion and an outside gas sucked from the outside gas suction port are blown; and
a gas supply passage which supplies the gases blown from the gas-amplifying section to a heat source or a vicinity of the heat source.

41. The exposure apparatus according to claim 40, wherein the groove portion of the gas-amplifying section has an adjustable width.

42. A method for producing a device, comprising:
forming a pattern of a photosensitive layer on a substrate by using the exposure apparatus as defined in claim 10; and
processing the substrate formed with the pattern.

43. A method for producing a device, comprising:
forming a pattern of a photosensitive layer on a substrate by using the exposure method as defined in claim 22; and
processing the substrate formed with the pattern.

44. A method for producing a device, comprising:
forming a pattern of a photosensitive layer on a substrate by using the exposure method as defined in claim 37; and
processing the substrate formed with the pattern.

45. A method for producing a device, comprising:
forming a pattern of a photosensitive layer on a substrate by using the exposure apparatus as defined in claim 29; and
processing the substrate formed with the pattern.

46. A method for producing a device, comprising:
forming a pattern of a photosensitive layer on a substrate by using the exposure apparatus as defined in claim 40; and
processing the substrate formed with the pattern.
